(19) United States
(12) Patent Application Publication
(10) Pub. No.: US 2019/0260070 A1
(43) Pub. Date: Aug. 22, 2019

(54) LITHIUM ION CONDUCTOR, ALL-SOLID-STATE BATTERY, ELECTRONIC DEVICE, ELECTRONIC CARD, WEARABLE DEVICE, AND ELECTRIC VEHICLE

(71) Applicant: Murata Manufacturing Co., Ltd., Nagaokakyo-shi (JP)

(72) Inventors: Kenji Kishimoto, Nagaokakyo-shi (JP); Masayuki Arimochi, Nagaokakyo-shi (JP); Masahiro Morooka, Nagaokakyo-shi (JP); Keisuke Shimizu, Nagaokakyo-shi (JP); Masamitsu Suzuki, Nagaokakyo-shi (JP)

(21) Appl. No.: 16/398,848

(22) Filed: Apr. 30, 2019

Related U.S. Application Data
(63) Continuation of application No. PCT/JP2017/037397, filed on Oct. 16, 2017.

(30) Foreign Application Priority Data
Nov. 15, 2016 (JP) 2016-222737

(51) Int. Cl. H01M 10/0525; H01M 4/134; H01M 4/133; H01M 4/38; H01M 10/0562; H01M 4/48; B60K 6/28; B60L 50/64

(52) U.S. Cl. CPC H01M 10/0525; H01M 4/134; H01M 4/133; H01M 4/386; H01M 4/387; H01M 2004/027; H01M 4/48; B60K 6/28; B60L 50/64; H01M 2220/20; H01M 2220/30; H01M 10/0562

(57) ABSTRACT

An all-solid-state battery that includes a positive electrode, a negative electrode, and an electrolyte layer. At least one of the positive electrode, the negative electrode, and the electrolyte layer includes a lithium ion conductor having an exothermic peak in a differential thermal analysis. The ionic conductivity on the side of the temperature higher than the rising temperature of the exothermic peak is lower than the ionic conductivity on the side of the temperature lower than the rising temperature of the exothermic peak.

### CROSS REFERENCE TO RELATED APPLICATIONS

The present application is a continuation of International application No. PCT/JP2017/037397, filed Oct. 16, 2017, which claims priority to Japanese Patent Application No. 2016-222737, filed Nov. 15, 2016, the entire contents of each of which are incorporated herein by reference.

### FIELD OF THE INVENTION

The present relates to a lithium ion conductor, an all-solid-state battery, an electronic device, an electronic card, a wearable device, and an electric vehicle.

### BACKGROUND OF THE INVENTION

In a lithium ion secondary battery using a general liquid type electrolyte, safety measures are taken to suppress the electrochemical reaction inside the battery that occurs during thermal runaway or the like. Such measures include a separator including an organic polymer melting by heat (refer to, for example, Patent Document 1). This separator has a shutdown function for stopping the runaway reaction by cutting off the path of ions flowing between the positive electrode and the negative electrode among the electrochemical reactions occurring inside the battery and by extremely lowering the conductivity.

Patent Document 1: Japanese Patent Application Laid-Open No. 2010-103050

### SUMMARY OF THE INVENTION

However, in an all-solid-state battery using a solid electrolyte instead of a liquid type electrolyte, it is not possible to use a separator including an organic polymer, and hence safety cannot be secured by the shutdown function of the separator.

In general, since the all-solid-state battery is composed only of solid materials, its safety is said to be higher than that of the ordinary liquid type battery using an electrolytic solution. However, when an all-solid-state battery is used for an electronic device (for example, a smartphone or the like), a thermal runaway of the all-solid-state battery may cause the inside of the electronic device to become abnormal. In most cases, a plastic material (hereinafter referred to as “peripheral material”) such as a circuit board is arranged around the all-solid-state battery in a hermetically sealed chassis of the electronic device, for example. Therefore, a thermal runaway of the all-solid-state battery may cause the peripheral member to be exposed to an abnormally high temperature, resulting in an abnormal state. Accordingly, a way of suppressing thermal runaway of all-solid-state batteries and improving safety is desired.

The object of the present is to provide an all-solid-state battery capable of suppressing thermal runaway, an electronic device, an electronic card, a wearable device, and an electric vehicle provided with the all-solid-state battery.

Further, the object of the present is to provide a lithium ion conductor capable of suppressing thermal runaway of an electrochemical device.

For solving the problem described above, a first aspect is an all-solid-state battery that includes a positive electrode, a negative electrode, and an electrolyte layer, wherein at least one of the positive electrode, the negative electrode, and the electrolyte layer includes a lithium ion conductor having an exothermic peak in a differential thermal analysis, and a first ionic conductivity on a first side of the temperature higher than the rising temperature of the exothermic peak is lower than a second ionic conductivity on a second side of the temperature lower than the rising temperature of the exothermic peak.

A second aspect is a lithium ion conductor having an exothermic peak in a differential thermal analysis, wherein a first ionic conductivity on a first side of the temperature higher than the rising temperature of the exothermic peak is lower than a second ionic conductivity on a second side of the temperature lower than the rising temperature of the exothermic peak.

A third aspect is an electronic device that receives a supply of power from an all-solid-state battery of the first aspect.

A fourth aspect is an electronic card that receives a supply of power from an all-solid-state battery of the first aspect.

A fifth aspect is a wearable device that receives a supply of power from an all-solid-state battery of the first aspect.

A sixth aspect is an electric vehicle having an all-solid-state battery of the first aspect, a conversion device that receives a supply of power from the all-solid-state battery and converts it to a driving force of the vehicle, and a control device that performs information processing related to vehicle control based on information related to the all-solid-state battery.

According to the present invention, an all-solid-state battery capable of suppressing thermal runaway can be realized. Further, a lithium ion conductor capable of suppressing thermal runaway of an electrochemical device can be realized.

It is to be noted that the effects described herein are not necessarily limited, and any of the effects described in the present disclosure or effects different from those described in the present disclosure may be applied.

### BRIEF EXPLANATION OF THE DRAWINGS

FIG. 1 is a cross-sectional view showing a configuration of a battery according to a first embodiment of the present invention.

FIG. 2 is a cross-sectional view showing a configuration of a battery according to a variation of the first embodiment of the present invention.

FIG. 3 is a cross-sectional view showing a configuration of a battery according to a second embodiment of the present invention.

FIG. 4 is an exploded perspective view showing a configuration of a laminate.

FIG. 5 is a cross-sectional view showing a configuration of a battery according to a third embodiment of the present invention.

FIG. 6 is a graph showing a temperature dependence of the ionic conductivity and the DTA curve of Example 3.

FIG. 7 is a perspective view showing an example of a printed circuit board as an application example of the present invention.

FIG. 8 is a plan view showing an appearance of a universal credit card as an application example of the present invention.

FIG. 9 is a block diagram of an example of a wireless sensor node as an application example of the present invention.

FIG. 10 is a perspective view showing an appearance of an example of a wristband type activity meter as an application example of the present invention.

FIG. 11 is a block diagram showing a configuration of a main part of a wristband type activity meter.

FIG. 12 is a perspective view showing an appearance of an example of a wristband type electronic device as an application example of the present invention.

FIG. 13 is a block diagram showing a configuration of an example of a wristband type electronic device.

FIG. 14 is a perspective view showing an overall configuration of a smartwatch as an application example of the present invention.

FIG. 15 is a perspective view showing an overall configuration of a smartwatch.

FIG. 16 is a perspective view showing a part of an internal configuration of a band type electronic device as an application example of the present invention.

FIG. 17 is a block diagram showing a circuit configuration of a band type electronic device.

FIG. 18 is a cross-sectional view for explaining a meandering state of a flexible circuit board.

FIG. 19 is a perspective view showing a state in which a battery is arranged in a segment.

FIG. 20 is a perspective view of an example of an eyeglass type terminal as an application example of the present invention.

FIG. 21 is a conceptual diagram of a first example of an image display device of an eyeglass type terminal.

FIG. 22 is a conceptual diagram of a second example of an image display device.

FIG. 23A is a conceptual diagram of a third example of an image display device. FIG. 23B is a schematic cross-sectional view showing a part of a reflection type volume hologram diffraction grating in an enlarged manner.

FIG. 24 is a conceptual diagram of a fourth example of an image display device.

FIG. 25 is a schematic diagram schematically showing an example of a configuration of a hybrid vehicle adopting a series hybrid system to which the present invention is applied.

FIG. 26 is a schematic diagram showing a power storage system for a residential house to which the present invention is applied.

### DETAILED DESCRIPTION OF THE INVENTION

### 1 First Embodiment

[Battery Configuration]

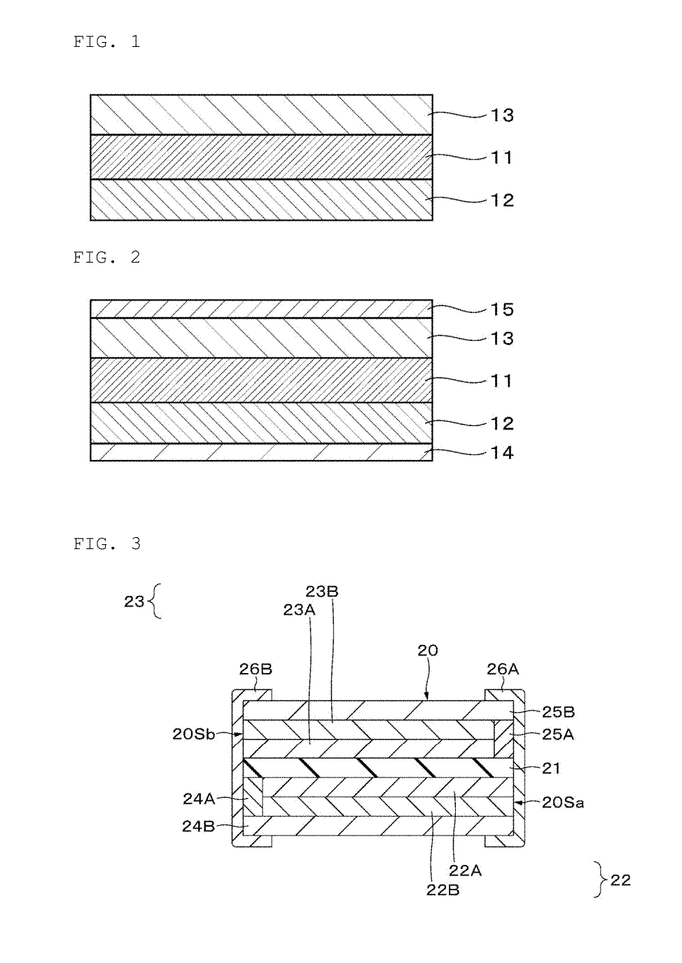

A battery according to the first embodiment of the present invention is a so-called bulk type all-solid-state battery that includes, as shown in FIG. 1, a solid electrolyte layer 11, a positive electrode layer 12 provided on one main surface of the solid electrolyte layer 11, and a negative electrode layer 13 provided on the other main surface of the solid electrolyte layer 11. This battery is a secondary battery in which the battery capacity can be repeatedly obtained by exchanging an electrode reactant Li, and it may be a lithium ion secondary battery in which the capacity of the negative electrode can be obtained by occluding and releasing a lithium ion or may be a lithium metal secondary battery in which the capacity of the negative electrode can be obtained by precipitating and dissolving lithium metal.

(Solid Electrolyte Layer)

The solid electrolyte layer 11 contains one or more types of solid electrolytes. The solid electrolyte is at least one type of oxide glass and oxide glass ceramics, which are lithium ion conductors, and from the viewpoint of improvement of the lithium ion conductivity, oxide glass ceramics is preferable. Oxide glass and oxide glass ceramics have a high stability to the atmosphere (moisture), and it is hence possible to omit the exterior material such as an aluminum laminate film. Omission of the exterior material can improve the energy density of the battery. The solid electrolyte layer 11 is a fired body of a green sheet (hereinafter referred to as a “solid electrolyte green sheet”) as a solid electrolyte layer precursor, for example.

Here, glass refers to those being crystallographically amorphous, where a halo is observed in X-ray diffraction or electron beam diffraction. Glass ceramics (crystallized glass) refers to those being crystallographically amorphous and crystalline mixed, where a peak and a halo are observed in X-ray diffraction and electron beam diffraction.

The lithium ion conductivity of the solid electrolyte is preferably 10⁻⁷S/cm or more from the viewpoint of improving the battery performance. The ionic conductivity is a value obtained by the alternating current impedance method as follows. First, a current collector is formed by depositing platinum on both surfaces of the solid electrolyte layer 11 as a sample by sputtering so as to have a thickness of 3 mmφ. Next, the solid electrolyte layer 11 is sandwiched between the jigs prepared using SUS304, and AC impedance is measured (frequency: 10⁺⁶ Hz to 10⁻¹ Hz, Voltage: 10 mV, 100 mV, 1000 mV) at room temperature (25° C.) using an impedance measuring device (Solartron 1260, manufactured by Toyo Technica Co.), thereby creating a Cole-Cole plot. Subsequently, the ionic conductivity is obtained from this Cole-Cole plot.

The solid electrolyte is a lithium ion conductor having an exothermic peak in differential thermal analysis. At the rising temperature Ta of the exothermic peak in the temperature rising process, the solid electrolyte starts crystallizing, and hence the ionic conductivity of the solid electrolyte decreases at the rising temperature Ta of the exothermic peak as a boundary. That is, the ionic conductivity on the side of the temperature higher than the rising temperature Ta of the exothermic peak in the temperature rising process is lower than the ionic conductivity on the side of the temperature lower than the rising temperature Ta of the exothermic peak in the temperature rising process (refer to FIG. 6). Since the ionic conductivity has such a property, thermal runaway of the battery can be suppressed.

The ionic conductivity in a temperature range from the rising temperature Ta to Ta+100° C. is preferably lower than the ionic conductivity at a temperature immediately before the reaching of the rising temperature Ta. The exothermic peak is an exothermic peak due to recrystallization of the lithium ion conductor. The above-mentioned crystallization process in the temperature rising process is usually an irreversible process. The temperature rising rate at the time of obtaining the differential thermal analysis (DTA) curve is 10° C./min. In the following description, “exothermic peak” means an exothermic peak in a temperature rising process by the differential thermal analysis.

It is known that the ionic conductivity tends to increase with the temperature rise of the solid electrolyte in a general solid electrolyte (for example, Li₃N, LiPON, LiBSO, Li_{3.4}V_{0.6}Ge_{0.4}O₄, La_{0.51}Li_{0.34}Ti_{02.94}, Li_{3.25}Ge_{0.25}P_{0.75}S₄, Li₂S—SiS₂—P₂S₅—LiI, Li₂S—SiS₂—Li₄SiO₄, Li₁₄Zn (GeO₄)₄, Li_{1.3}Al_{0.3}Ti_{1.7} (PO4)₃, LiSON, LiSiPON, and so on) (refer to P. Knauth/Solid State Ionics 180 (2009) 911-916). Accordingly, it is difficult to obtain an effect of suppressing thermal runaway of the battery in a general solid electrolyte.

The reduction rate of the ionic conductivity expressed by the following formula (1) is preferably 85% or more, more preferably 90% or more, and yet more preferably 95% or more. When the reduction rate is 85% or more, the battery can be given a shutdown function, thereby further improving the safety of the battery. Here, the shutdown function refers to a function of suppressing ion conduction between the positive electrode layer 12 and the negative electrode layer 13 so that the reduction rate of the ionic conductivity becomes 85% or more.

Reduction rate of ionic conductivity [%]=[(σ(lowT)−σ(highT))/σ(lowT)]×100 (1)

(σ(lowT)[S/cm] is preferably an ionic conductivity at Ta [° C.]−40 [° C.], more preferably an ionic conductivity at Ta [° C.]−25 [° C.]. σ(highT)[S/cm] is preferably an ionic conductivity at Ta [° C.]+40 [° C.], more preferably an ionic conductivity at Ta [° C.]+25 [° C.]. Ta is the rising temperature [° C.] of the exothermic peak (refer to FIG. 6).)

Here, the ionic conductivities σ(lowT) and σ(highT) are values calculated in the same manner as the measurement of the lithium ion conductivity described above except for performing the AC impedance measurement while adjusting (raising) the temperature of a heating stage so that the sample reaches a predetermined temperature on the heating stage. The temperature rising rate is 10° C./min.

The rising temperature Ta of the exothermic peak falls within preferably 300° C. to 550° C., more preferably 350° C. to 550° C., and yet more preferably 350° C. to 500° C.

If the rising temperature Ta of the exothermic peak is lower than 300° C., the firing temperature cannot be made 300° C. or higher in the battery manufacturing process, and thus there is a possibility that the organic binder cannot be dissipated in the battery manufacturing process. In the case where the negative electrode active material contains a carbon material, when the battery exceeds 550° C. in temperature, the carbon material is lost or dissipated, and thermal runaway of the battery is suppressed. If the rising temperature Ta of the exothermic peak is 550° C. or lower, thermal runaway of the battery can be suppressed in a temperature range lower than the temperature range where the carbon material is lost or dissipated as described above. The ionic conductivity of the solid electrolyte decreases in the temperature range 300° C. to 550° C., and the carbon material contained in the negative electrode active material is lost or dissipated in the temperature range exceeding 550° C. It is thus possible to further improve the safety of battery.

In the case where the electronic device using the battery includes a board containing a polymer resin, it is preferable that the rising temperature Ta of the exothermic peak in the temperature rising process is less than the ignition point of the polymer resin contained in the board. This is because the electronic device can be suppressed from entering an abnormal state. In the case where the board contains a plurality of types of polymer resins, the “ignition point of the polymer resin contained in the board” refers to the ignition point of a polymer resin having the lowest ignition point among the plurality of types of polymer resins contained in the board. As the polymer resin for the board, a phenol resin or an epoxy resin is commonly used.

In the case where the electronic device using the battery includes a chassis containing a polymer resin, it is preferable that the rising temperature Ta of the exothermic peak in the temperature rising process is less than the ignition point of the polymer resin contained in the chassis. This is because the electronic device can be suppressed from entering an abnormal state. In the case where the chassis contains a plurality of types of polymer resins, the “ignition point of the polymer resin contained in the chassis” refers to the ignition point of a polymer resin having the lowest ignition point among the plurality of types of polymer resins contained in the chassis. Copolymer synthetic resins (ABS resin) of acrylonitrile, butadiene, and styrene, a polycarbonate (PC) resin, and a PC-ABS alloy resin are commonly used as the polymer resin used for the chassis.

In the case where the electronic device using the battery includes both a board containing a polymer resin and a chassis containing a polymer resin, it is preferable that the rising temperature Ta of the exothermic peak in the temperature rising process is less than the ignition point of the polymer resin having the lowest ignition point among the polymer resins contained in the chassis and the electronic device.

The solid electrolyte contained in the solid electrolyte layer 11 has been sintered. The sintering temperature of oxide glass and oxide glass ceramics, which are solid electrolytes, is preferably 300° C. to 550° C., more preferably 350° C. to 550° C., and yet more preferably 350° C. to 500° C.

When the sintering temperature is 550° C. or lower, burn-off of carbon material is suppressed in the firing process (sintering process), so that it is possible to use a carbon material as a negative electrode active material. Accordingly, the energy density of the battery can be improved. When the positive electrode layer 12 contains a conductive agent, a carbon material can be used as the conductive agent.

Therefore, it is possible to form a good electronic conduction path in the positive electrode layer 12 and improve the conductivity of the positive electrode layer 12. Even when the negative electrode layer 13 contains a conductive agent, a carbon material can be used as the conductive agent, and the conductivity of the negative electrode layer 13 can thus be improved.

When the sintering temperature is 550° C. or lower, it is possible to suppress the formation of by-products such as passivation by reacting the solid electrolyte and the electrode active material in the firing process (sintering process). Accordingly, deterioration of the battery characteristics can be suppressed. In addition, when the firing temperature is as low as 550° C. or lower, the range of choice of the type of the electrode active material is widened, thereby improving the degree of freedom of battery design.

On the other hand, when the sintering temperature is 300° C. or higher, it is possible to burn off the common organic binder such as an acrylic resin contained in the electrode precursor and/or the solid electrolyte layer precursor in the firing process (sintering process).

As oxide glass and oxide glass ceramics, those containing at least one of Ge (germanium), Si (silicon), B (boron), W (tungsten), and P (phosphorus); Li (lithium), and O (Oxygen) are preferable, and those containing Si, B, W, Li, and Oare more preferable.

Specifically, those containing at least one of germanium oxide (GeO₂), silicon oxide (SiO₂), boron oxide (B₂O₃), tungsten oxide (WO₃), and phosphorus oxide (P₂O₅); and lithium oxide (Li₂O) are preferable, and those containing SiO₂, B₂O₃, WO₃, and Li₂O are more preferable. As described above, oxide glass and oxide glass ceramics containing at least one of Ge, Si, B, W, and P; Li, and O have a sintering temperature 300° C. to 550° C., have a high thermal shrinkage ratio, and are rich in fluidity, and hence it is advantageous from the viewpoint of reduction in interface resistance, improvement in energy density of the battery, and the like.

From the viewpoint of lowering the sintering temperature of the solid electrolyte, the content of Li₂O is preferably 20 mol % to 75 mol %, more preferably 30 mol % to 75 mol %, yet more preferably 40 mol % to 75 mol %, and particularly preferably 50 mol % to 75 mol %.

When the solid electrolyte contains GeO₂, the content of GeO₂ is preferably more than 0 mol % to 80 mol %. When the solid electrolyte contains SiO₂, the content of SiO₂ is preferably more than 0 mol % to 70 mol %, for example, more than 0 mol % to 20 mol %. When the solid electrolyte contains B₂O₃, the content of B₂O₃ is preferably more than 0 mol % to 60 mol %, for example, more than 0 mol % to 45 mol %. When the solid electrolyte contains WO₃, the content of WO₃ is preferably more than 0 mol % to 5 mol %. When the solid electrolyte contains P₂O₅, the content of P₂O₅ is preferably more than 0 mol % to 50 mol %.

The content of each of the oxides described above is the content of each of the oxides in a solid electrolyte. Specifically, the proportion of the content (mol) of each of the oxides with respect to the total amount (mol) of one or more of GeO₂, SiO₂, B₂O₃, WO₃, and P₂O₅; and Li₂O is shown as a percentage (mol %). The content of each of the oxides can be measured using inductively coupled plasma atomic emission spectroscopy (ICP-AES) or the like.

The solid electrolyte may further contain an additional element if necessary. The additional elements include at least one selected from the group consisting of Na (sodium), Mg (magnesium), Al (aluminum), K (potassium), Ca (calcium), Ti (titanium), V (vanadium), Cr (chromium), Mn (manganese), Fe (iron), Co (cobalt), Ni (nickel), Cu (copper), Zn (zinc), Ga (gallium), Se (selenium), Rb (rubidium), S (sulfur), Y (yttrium), Zr (zirconium), Nb (niobium), Mo (molybdenum), Ag (silver), In (indium), Sn (tin), Sb (antimony), Cs (cesium), Ba (barium), Hf (hafnium), Ta (tantalum), Pb (lead), Bi (bismuth), Au (gold), La (lanthanum), Nd (neodymium), and Eu (europium), for example. The solid electrolyte may contain, as an oxide, at least one selected from the group consisting of these additional elements.

(Positive Electrode Layer)

The positive electrode layer 12 is a positive electrode active material layer containing one or more types of positive electrode active materials and one or more types of solid electrolytes. The solid electrolyte may have a function as a binder. The positive electrode layer 12 may further contain a conductive agent, if necessary. The positive electrode layer 12 is, for example, a fired body of a green sheet (hereinafter referred to as a “positive electrode green sheet”) as a positive electrode layer precursor.

The positive electrode active material contains, for example, a positive electrode material capable of occluding and releasing a lithium ion, which is an electrode reactant. From the viewpoint of obtaining a high energy density, the positive electrode material is preferably a lithium-containing compound or the like but not limited thereto. The lithium-containing compound is, for example, a composite oxide (lithium transition metal composite oxide) containing lithium and a transition metal element as constituent elements, a phosphate compound (lithium transition metal phosphate compound) containing lithium and a transition metal element as constituent elements, and the like. Among them, the transition metal element is preferably any one or more types of Co, Ni, Mn, and Fe. Due to this, when a higher voltage is obtained and the voltage of the battery can be increased, the energy (Wh) of the battery having the same capacity (mAh) can be increased.

The lithium transition metal composite oxide is expressed by, for example, LiₓM1O₂, Li_{y}M2O₄, or the like.

More specifically, for example, the lithium transition metal composite oxide is LiCoO₂, LiNiO₂, LiVO₂, LiCrO₂, LiMn₂O₄, or the like. Further, the lithium transition metal phosphate compound is expressed by, for example, Li_{z}M3PO₄ or the like. More specifically, for example, the lithium transition metal phosphate compound is LiFePO₄, LiCoPO₄, or the like. However, M1 to M3 are one or more types of transition metal elements, and the values of x to z are arbitrary.

In addition to this, the positive electrode active material may be, for example, an oxide, a disulfide, a chalcogenide, a conductive polymer, or the like. The oxide is, for example, titanium oxide, vanadium oxide, manganese dioxide, or the like. The disulfide is, for example, titanium disulfide, molybdenum sulfide, or the like. The chalcogenide is, for example, niobium selenide or the like. Examples of the conductive polymer are disulfide, polypyrrole, polyaniline, polythiophene, polyparastylene, polyacetylene, polyacene, or the like.

The solid electrolyte is similar to that contained in the solid electrolyte layer 11 described above. However, the composition (material) or the composition ratio of the solid electrolyte contained in the solid electrolyte layer 11 and the positive electrode layer 12 may be the same or may be different.

The conductive agent is, for example, at least one of a carbon material, a metal, a metal oxide, a conductive polymer, and the like. As the carbon material, for example, graphite, carbon fiber, carbon black, carbon nanotube, or the like can be used.

As the carbon fiber, for example, vapor growth carbon fiber (VGCF) or the like can be used. As the carbon black, for example, acetylene black, Ketjen black, or the like can be used. As the carbon nanotube, for example, a single-wall carbon nanotube (SWCNT), a multi-wall carbon nanotube (MWCNT) such as a double-wall carbon nanotube (DWCNT), or the like can be used. As the metal, for example, Ni powder or the like can be used.

As the metal oxide, for example, SnO₂ or the like can be used. As the conductive polymer, for example, substituted or unsubstituted polyaniline, polypyrrole, polythiophene, (co)polymers composed of one or two types selected from these, or the like can be used. Note that the conductive agent may be a material having conductivity, and is not limited to the above examples.

(Negative Electrode Layer)

The negative electrode layer 13 is a negative electrode active material layer containing one or more types of negative electrode active materials and one or more types of solid electrolytes. The solid electrolyte may have a function as a binder. The negative electrode layer 13 may further contain a conductive agent, if necessary. The negative electrode layer 13 is, for example, a fired body of a green sheet (hereinafter referred to as a “negative electrode green sheet”) as a negative electrode layer precursor.

The negative electrode active material contains, for example, a negative electrode material capable of occluding and releasing a lithium ion, which is an electrode reactant. From the viewpoint of obtaining a high energy density, the negative electrode material is preferably a carbon material or a metal-based material, but is not limited thereto.

The carbon material is, for example, graphitizable carbon, non-graphitizable carbon, graphite, mesocarbon microbeads (MCMB), highly oriented graphite (HOPG), or the like.

The metal-based material is, for example, a material containing, as a constituent element, a metal element or a semimetal element capable of forming an alloy with lithium. More specifically, for example, the metal-based material is one or more types of a simple substance, an alloy, or a compound of Si (silicon), Sn (tin), Al (aluminum), In (indium), Mg (magnesium), B (boron), Ga (gallium), Ge (germanium), Pb (lead), Bi (bismuth), Cd (cadmium), Ag (silver), Zn (zinc), Hf (hafnium), Zr (zirconium), Y (yttrium), Pd (palladium), Pt (platinum), or the like. However, the simple substance is not limited to be 100% in purity, and it may contain trace impurities. Examples of the alloy or the compound include SiB₄, TiSi₂, SiC, Si₃N₄, SiOᵥ (0<v<2), LiSiO, SnO_{w} (0<w<2), SnSiO₃, LiSnO, and Mg₂Sn.

The metal-based material may be a lithium-containing compound or a lithium metal (a simple substance of lithium). The lithium-containing compound is a composite oxide (lithium transition metal composite oxide) containing lithium and a transition metal element as constituent elements. Examples of this composite oxide include Li₄Ti₅O₁₂.

The solid electrolyte is similar to that contained in the solid electrolyte layer 11 described above. However, the composition (material) or the composition ratio of the solid electrolyte contained in the solid electrolyte layer 11 and the negative electrode layer 13 may be the same or may be different.

The conductive agent is the same as the conductive agent in the positive electrode layer 12 described above.

(Battery Operation)

In this battery, for example, at the time of charging, a lithium ion released from the positive electrode layer 12 is taken into the negative electrode layer 13 via the solid electrolyte layer 11, and at the time of discharging, a lithium ion released from the negative electrode layer 13 is taken into the positive electrode layer 12 via the solid electrolyte layer 11.

[Method for Manufacturing Battery]

Next, an example of a method for manufacturing a battery according to the first embodiment of the present invention will be described. This manufacturing method includes a process of forming a positive electrode layer precursor, a negative electrode layer precursor, and a solid electrolyte layer precursor, and a process of laminating and firing these precursors.

(Formation Process of Positive Electrode Layer Precursor)

A positive electrode green sheet as a positive electrode layer precursor is formed in the following manner. First, a positive electrode active material, a solid electrolyte, an organic binder, and, if necessary, a conductive agent are mixed to prepare a positive electrode mixture powder, and then this mixture powder is dispersed in a solvent, thereby obtaining a slurry as a positive electrode green sheet forming composition. In order to improve the dispersibility of the mixture powder, the dispersion may be carried out several times.

As the organic binder, for example, an acrylic resin or the like can be used. While the solvent is not particularly limited as long as it can disperse the positive electrode mixture powder, the one that burns off in a temperature range lower than the firing temperature of the positive electrode green sheet is preferable. As the solvent, for example, lower alcohols having 4 or less carbon atoms such as methanol, ethanol, isopropanol, n-butanol, sec-butanol, and t-butanol; aliphatic glycols such as ethylene glycol, propylene glycol (1,3-propanediol), 1,3-propanediol, 1,4-butanediol, 1,2-butanediol, 1,3-butanediol, and 2-methyl-1,3-propanediol; ketones such as methyl ethyl ketone; amines such as dimethylethylamine; alicyclic alcohols such as terpineol, and the like can be used alone or in a mixture of two or more, but it is not particularly limited thereto. Examples of the dispersion method include agitation treatment, ultrasonic dispersion treatment, bead dispersion treatment, kneading treatment, and homogenizer treatment.

Next, if necessary, foreign substances in the slurry may be removed by filtering the slurry with a filter. Next, if necessary, vacuum degassing may be performed on the slurry to remove internal bubbles.

Next, the slurry is uniformly applied or printed on the surface of the supporting substrate to form a slurry layer. As the supporting substrate, for example, a polymer resin film such as polyethylene terephthalate (PET) or the like can be used.

As the application and printing methods, use of a simple method suitable for mass productivity is preferable. As the application method, a die coating method, a micro gravure coating method, a wire bar coating method, a direct gravure coating method, a reverse roll coating method, a comma coating method, a knife coating method, a spray coating method, a curtain coating method, a dipping method, a spin coating method, or the like can be used, but it is not particularly limited thereto. As a printing method, for example, a relief printing method, an offset printing method, a gravure printing method, an intaglio printing method, a rubber plate printing method, a screen printing method, or the like can be used, but it is not particularly limited thereto.

In order to facilitate peeling of the positive electrode green sheet from the surface of the supporting substrate in the post-process, it is preferable to apply peeling treatment to the surface of the supporting substrate beforehand. Examples of the peeling treatment include a method of applying or printing on the surface of the supporting substrate beforehand a composition that imparts the peeling property. Examples of the composition that imparts the peeling property include a paint containing a binder as a main component and to which wax, fluorine, or the like is added and a silicone resin.

Next, the positive electrode green sheet is formed on the surface of the supporting substrate by drying the slurry layer. Examples of the drying method include air drying by natural drying, hot air, and the like, heat drying by infrared ray, far-infrared ray, and the like, and vacuum drying. These drying methods may be used alone or in combination of two or more.

(Formation Process of Negative Electrode Layer Precursor)

A negative electrode green sheet as a negative electrode layer precursor is formed in the following manner. First, a negative electrode active material, a solid electrolyte, an organic binder, and, if necessary, a conductive agent are mixed to prepare a negative electrode mixture powder, and then this mixture powder is dispersed in a solvent, thereby obtaining a slurry as a negative electrode green sheet forming composition. The negative electrode green sheet is obtained in the same manner as the above-mentioned “Formation Process of Positive Electrode Layer Precursor” except for using this slurry.

(Formation Process of Solid Electrolyte Layer Precursor)

The solid electrolyte green sheet as a solid electrolyte layer precursor is formed in the following manner. First, a solid electrolyte and an organic binder are mixed to prepare an electrolyte mixture powder, and then this mixture powder is dispersed in a solvent, thereby obtaining a slurry as a solid electrolyte green sheet forming composition. The solid electrolyte green sheet is obtained in the same manner as the above-mentioned “Formation Process of Positive Electrode Layer Precursor” except for using this slurry.

(Lamination and Firing Process of Precursor)

Using the positive electrode green sheet, the negative electrode green sheet, and the solid electrolyte green sheet obtained as described above, a battery is produced as follows. First, each of the green sheets is cut into a predetermined size and shape. Next, the positive electrode green sheet and the negative electrode green sheet are laminated so as to sandwich the solid electrolyte green sheet to form a laminate. If the green sheet on each of the supporting boards has a thickness such that the green sheet can be handled alone, after peeling each of the green sheets off from the supporting board with tweezers or the like, for example, the negative electrode, the solid electrolyte, and the positive electrode are pressure bonded and laminated on the SUS board in this order. When the green sheet is thin, after pressure bonding the green sheet on the supporting board so that the green sheet and the board face each other on the SUS board, only the supporting board is peeled off from the SUS board.

The laminate is formed by repeating this operation in order of the negative electrode, the solid electrolyte, and the positive electrode.

Thereafter, the laminate is heated, and at the same time, the laminate is pressed so that pressure is applied at least in the thickness direction of the laminate. As a result, the organic binder contained in each of the green sheets constituting the laminate is melted, and the green sheets constituting the laminate are closely adhered to each other. Examples of a specific method of pressing the laminate while heating it include a hot press method and a warm isostatic press (WIP) method. Next, by firing the laminate, the solid electrolyte contained in each of the green sheets constituting the laminate is sintered and the organic binder is burned off.

Note that the solid electrolyte contained in the positive electrode green sheet, the negative electrode green sheet, and the solid electrolyte green sheet is at least one type of oxide glass and oxide glass ceramics before the firing process.

The firing temperature of the laminate is equal to or higher than the sintering temperature of the solid electrolyte, preferably equal to or higher than the sintering temperature of the solid electrolyte and 550° C. or lower, and more preferably equal to or higher than the sintering temperature of the solid electrolyte and 500° C. or lower. Here, the sintering temperature of the solid electrolyte refers to the sintering temperature of the solid electrolyte when the laminate contains only one type of solid electrolyte. On the other hand, it refers to the minimum temperature of the sintering temperatures of those solid electrolytes when the laminate contains two or more types of solid electrolytes.

When the firing temperature of the laminate is equal to or higher than the sintering temperature of the solid electrolyte, the sintering of the solid electrolyte proceeds, and hence the lithium ion conductivity of the positive electrode layer 12, the negative electrode layer 13, and the solid electrolyte layer 11 can be improved. In addition, the strength of the positive electrode layer 12, the negative electrode layer 13, and the solid electrolyte layer 11 can be increased. The reason for setting the firing temperature of the laminate to 550° C. or lower is the same as the reason for setting the sintering temperature of the solid electrolyte to 550° C. or lower.

The rising temperature Ta of the exothermic peak of the solid electrolyte in the temperature rising process preferably exceeds the firing temperature in the manufacturing process of the battery. If the rising temperature Ta of the exothermic peak is equal to or lower than the firing temperature in the manufacturing process of the battery, the ionic conductivity of the solid electrolyte decreases in the manufacturing process of the battery, and the function of the battery may be impaired. In the case where firing is performed a plurality of times in the manufacturing process of the battery, the rising temperature Ta of the exothermic peak preferably exceeds the highest firing temperature among the firing temperatures.

In the case where the solid electrolyte contained in the laminate before the firing process is oxide glass, the solid electrolyte may be changed from oxide glass to oxide glass ceramics in the firing process. Thus, a target battery can be obtained.

[Effects]

In the battery according to the first embodiment, the positive electrode layer 12, the negative electrode layer 13, and the solid electrolyte layer 11 include a solid electrolyte (lithium ion conductor) having an exothermic peak in differential thermal analysis. The ionic conductivity on the side of the temperature higher than the rising temperature Ta of the exothermic peak is lower than the ionic conductivity on the side of the temperature lower than the rising temperature Ta of the exothermic peak. Therefore, a function of suppressing thermal runaway can be imparted to the battery. Accordingly, the safety of the battery can be improved.

[Variations]

The solid electrolyte according to the first embodiment may be used as a mixture with another solid electrolyte. Specifically, the positive electrode layer 12, the negative electrode layer 13, and the solid electrolyte layer 11 may further include a solid electrolyte other than the solid electrolyte according to the first embodiment. As the solid electrolyte other than the solid electrolyte according to the first embodiment, for example, a general solid electrolyte such as a phosphate compound (LATP) containing a perovskite type oxide crystal composed of La—Li—Ti—O and the like, a garnet type oxide crystal composed of Li—La—Zr—O and the like, lithium, aluminum, and titanium as constituent elements; and a phosphate compound (LAGP) containing lithium, aluminum, and germanium as constituent elements can be used.

The solid electrolyte according to the first embodiment can also be used for primary batteries, secondary batteries (such as all-solid-state sodium batteries), air batteries, fuel cells, and the like other than all-solid-state lithium ion batteries. The solid electrolyte according to the first embodiment can also be used for electrochemical devices other than batteries such as capacitors and gas sensors.

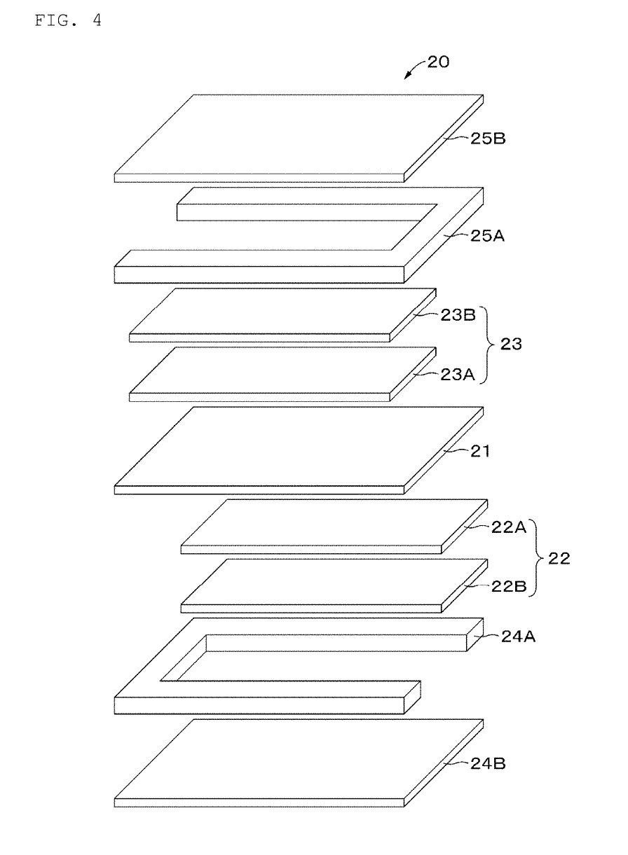

As shown in FIG. 2, the battery may further include a positive electrode collector layer 14 provided on one main surface of the positive electrode layer 12 and a negative electrode collector layer 15 provided on one main surface of the negative electrode layer 13. In this case, the solid electrolyte layer 11 is provided between the other main surface of the positive electrode layer 12 and the other main surface of the negative electrode layer 13. Although not illustrated, the battery may be provided with only a layer of one of the positive electrode collector layer 14 and the negative electrode collector layer 15.

The positive electrode collector layer 14 is a metal layer containing, for example, Al, Ni, stainless steel, and the like. The negative electrode collector layer 15 is a metal layer containing, for example, Cu, stainless steel, and the like. The shape of the metal layer is, for example, a foil shape, a plate shape, a mesh shape, or the like. The positive electrode collector layer 14 and the negative electrode collector layer 15 may be a fired body of green sheet containing a conductive grain and a solid electrolyte.

While in the above-described first embodiment, an example has been described in which the present invention is applied to a battery using lithium as an electrode reactant, the present invention is not limited to this example. The present invention may be applied to a battery using, for example, another alkali metal such as Na or K, an alkaline earth metal such as Mg or Ca, or another metal such as Al or Ag as the electrode reactant.

The battery may have a bipolar type laminate structure. Further, instead of constituting all layers of the battery by green sheets, some layers constituting the battery may be formed by green sheets, and other layers may be directly formed on the green sheets by printing or the like.

Specifically, for example, at least one of the positive electrode layer precursor and the negative electrode layer precursor may be formed as follows. That is, a positive electrode slurry may be applied or printed on one surface of the solid electrolyte layer precursor or the solid electrolyte layer 11 and then dried to form the positive electrode layer precursor. Alternatively, a negative electrode slurry may also be applied or printed on the other surface of the solid electrolyte layer precursor or the solid electrolyte layer 11 and then dried to form the negative electrode layer precursor.

While in the above-described first embodiment, the case has been described as an example where the positive electrode layer precursor, the negative electrode layer precursor, and the solid electrolyte layer precursor are green sheets, the positive electrode layer precursor, the negative electrode layer precursor, and the solid electrolyte layer precursor may be a green compact. The precursor of one layer or two layers of the positive electrode layer precursor, the negative electrode layer precursor, and the solid electrolyte layer precursor may be a green sheet and the remainder may be a green compact. The green compact serving as the positive electrode layer precursor is produced by pressure forming the positive electrode mixture powder by a press machine or the like. The green compact serving as the negative electrode layer precursor is produced by pressure forming the negative electrode mixture powder by a press machine or the like. The green compact serving as the solid electrolyte layer precursor is produced by pressure forming the electrolyte mixture powder by a press machine or the like. In addition, the positive electrode mixture powder, the negative electrode mixture powder, and the electrolyte mixture powder may not contain an organic binder.

While in the above-described first embodiment, the example is described in which the positive electrode layer precursor, the solid electrolyte layer precursor, and the negative electrode layer precursor are laminated and then fired, the positive electrode layer precursor, the solid electrolyte layer precursor, and the negative electrode layer precursor may be fired to form a fired body (sintered body) and then a laminate may be formed by laminating these fired bodies. In this case, the laminate may not be fired after pressing the laminate, or, if necessary, the laminate may be fired after pressing the laminate.

In the above-described first embodiment, a structure has been described as an example in which all of the solid electrolyte layer 11, the positive electrode layer 12, and the negative electrode layer 13 include the solid electrolyte where the ionic conductivity on the side of the temperature higher than the rising temperature Ta of the exothermic peak is lower than the ionic conductivity on the side of the temperature lower than the rising temperature Ta of the exothermic peak. However, at least one of the solid electrolyte layer 11, the positive electrode layer 12, and the negative electrode layer 13 may include the solid electrolyte having the above characteristics.

While in the above-described first embodiment, the case has been described as an example where both of the positive electrode layer 12 and the negative electrode layer 13 are electrodes including the solid electrolyte, at least one of the positive electrode layer 12 and the negative electrode layer 13 may also be an electrode not including the solid electrolyte. In this case, the electrode not including the solid electrolyte may be a thin film produced by a vapor growth method such as a vapor deposition method or a sputtering method.

While in the above-described first embodiment, the case has been described where the solid electrolyte as the lithium ion conductor is at least one type of oxide glass and oxide glass ceramics, the solid electrolyte is not limited to this. The solid electrolyte can be used if it has an exothermic peak in differential thermal analysis and the ionic conductivity on the side of the temperature higher than the rising temperature Ta of the exothermic peak is lower than the ionic conductivity on the side of the temperature lower than the rising temperature Ta of the exothermic peak.

The rising temperature Ta of the exothermic peak may be higher than 550° C. and 600° C. or lower. When the rising temperature Ta of the exothermic peak is in the temperature range described above, the following effects can be obtained if the negative electrode layer 13 contains a carbon material. That is, the ionic conductivity of the solid electrolyte layer 11 decreases in the temperature range described above, and the carbon material contained in the negative electrode layer 13 is lost or dissipated, and hence the safety of the battery can be further improved.

### 2 Second Embodiment

[Battery Configuration]

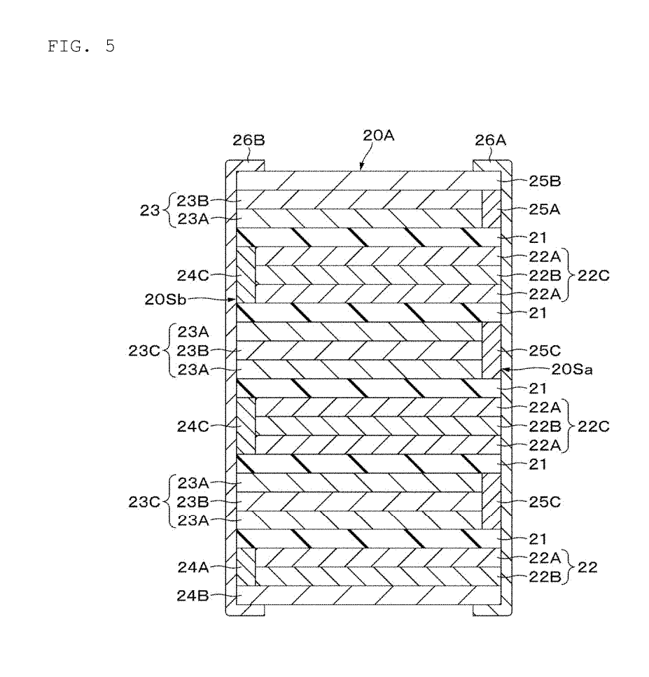

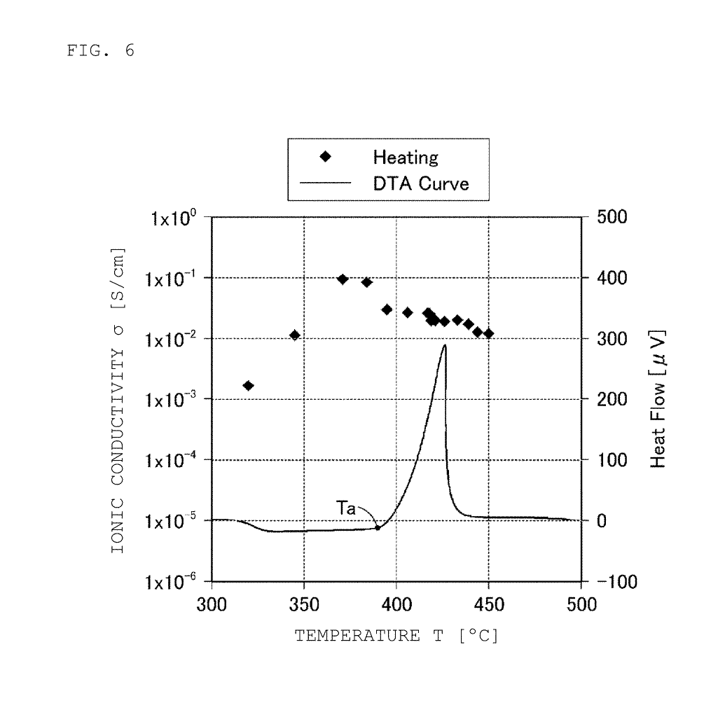

The battery according to the second embodiment of the present invention includes, as shown in FIG. 3, a laminate 20, a positive electrode terminal 26A and a negative electrode terminal 26B, which are in contact with a positive electrode exposed portion and a negative electrode exposed portion, respectively, exposed from a side surface of the laminate 20. As shown in FIG. 3 and FIG. 4, the laminate 20 includes a solid electrolyte layer 21, a positive electrode 22 and insulation layers 24A and 24B laminated on one main surface of the solid electrolyte layer 21, and a negative electrode 23 and insulation layers 25A and 25B laminated on the other main surface of the solid electrolyte layer 21.

The positive electrode 22 includes a positive electrode layer 22A provided on one main surface of the solid electrolyte layer 21 and a positive electrode collector layer 22B provided on one main surface of the positive electrode layer 22A. The negative electrode 23 includes a negative electrode layer 23A provided on the other main surface of the solid electrolyte layer 21 and a negative electrode collector layer 23B provided on the other main surface of the negative electrode layer 23A. Although not illustrated, only one layer of the positive electrode collector layer 22B and the negative electrode collector layer 23B may be included.

The laminate 20 has a rectangular plate shape and has a first side surface 20Sa and a second side surface 20Sb opposed to each other. The side surface of the positive electrode 22 is covered with the insulation layer 24A so that the side surface of the positive electrode 22 is exposed from the side of the first side surface 20Sa.

The side surface of the positive electrode 22 exposed from the first side surface 20Sa is in contact with the positive electrode terminal 26A. The side surface of the negative electrode 23 is covered with the insulation layer 25A so that the side surface of the negative electrode 23 is exposed from the side of the second side surface 20Sb. The side surface of the negative electrode 23 exposed from the second side surface 20Sb is in contact with the negative electrode terminal 26B. One main surface of the laminate 20 is covered with the insulation layer 24B, and the other main surface of the laminate 20 is covered with the insulation layer 25B.

The main surfaces of the solid electrolyte layer 21 and the insulation layers 24B and 25B have rectangular shapes having substantially the same size. The main surfaces of the positive electrode 22 and the negative electrode 23 have rectangular shapes having substantially the same size. The size of the main surfaces of the positive electrode 22 and the negative electrode 23 is slightly smaller than the size of the main surfaces of the solid electrolyte layer 21 and the insulation layers 24B and 25B.

In a plan view of the insulation layer 24A from the direction perpendicular to one main surface of the positive electrode 22, the insulation layer 24A has a U shape and is provided between peripheral portions of the main surfaces of the solid electrolyte layer 21 and the insulation layer 24B so as to cover three side surfaces of the side surfaces of the positive electrode 22. One main surfaces of the positive electrode 22 and the insulation layer 24A have substantially the same height and are covered with the insulation layer 24B.

In plan view of the insulation layer 25A from the direction perpendicular to the other main surface of the negative electrode 23, the insulation layer 25A has a U shape and is provided between peripheral portions of the main surfaces of the solid electrolyte layer 21 and the insulation layer 25B so as to cover three side surfaces of the side surfaces of the negative electrode 23. The other main surfaces of the negative electrode 23 and the insulation layer 25A have substantially the same height and are covered with the insulation layer 25B.

(Solid Electrolyte Layer, Positive Electrode Layer, and Negative Electrode Layer)

The solid electrolyte layer 21, the positive electrode layer 22A, and the negative electrode layer 23A have the same configuration as that of the solid electrolyte layer 11, the positive electrode layer 12, and the negative electrode layer 13 in the first embodiment, respectively.

(Positive Electrode Collector Layer and Negative Electrode Collector Layer)

The positive electrode collector layer 22B and the negative electrode collector layer 23B contain a conductive grain and oxide glass or oxide glass ceramics. The positive electrode collector layer 22B is a fired body of a green sheet (hereinafter referred to as a “positive electrode collector green sheet”) as a positive electrode collector layer precursor, for example. The negative electrode collector layer 23B is a fired body of a green sheet (hereinafter referred to as a “negative electrode collector green sheet”) as a negative electrode collector layer precursor, for example.

Examples of the shape of the conductive grain include sphere-like, ellipsoid-like, needle-like, plate-like, scale-like, tube-like, wire-like, bar-like (rod-like), and irregular shape, but it is not particularly limited thereto. Two or more types of grains having the shapes described above may be used in combination.

The conductive grain is an inorganic grain having conductivity. The inorganic grain is at least one type of a metal grain, a metal oxide grain, and a carbon grain. Here, the metal is defined as including semimetal. Examples of the metal grain include the metal such as copper, silver, gold, platinum, palladium, nickel, tin, cobalt, rhodium, iridium, iron, ruthenium, osmium, manganese, molybdenum, tungsten, niobium, tantalum, titanium, bismuth, antimony, and lead, or an alloy thereof, but it is not limited thereto. Examples of the metal oxide grain include indium tin oxide (ITO), zinc oxide, indium oxide, antimony-added tin oxide, fluorine-added tin oxide, aluminum-added zinc oxide, gallium-added zinc oxide, silicon-added zinc oxide, zinc oxide-tin oxide system, indium oxide-tin oxide system, and zinc oxide-indium oxide-magnesium oxide system, but it is not limited thereto.

Examples of the carbon grain include carbon black, porous carbon, carbon fiber, fullerene, graphene, carbon nanotube, carbon microcoil, and nanohorn, but it is not limited thereto.

The oxide glass and the oxide glass ceramics are the same as the oxide glass and the oxide glass ceramics contained in the solid electrolyte layer 21, respectively.

(Insulation Layer)

The insulation layers 24A, 24B, 25A, and 25B include insulation grains and oxide glass or oxide glass ceramics. The insulation layers 24A, 24B, 25A, and 25B are fired bodies of a green sheet (hereinafter referred to as an “insulation green sheet”) as an insulation layer precursor, for example.

Examples of the shape of the insulation grain include sphere-like, ellipsoid-like, needle-like, plate-like, scale-like, tube-like, wire-like, bar-like (rod-like), and irregular shape, but it is not particularly limited thereto. Two or more types of grains having the shapes described above may be used in combination.

The insulation grain is an inorganic grain having an electrical insulation property. This inorganic grain is at least one type of aluminum oxide (alumina, Al₂O₃), silicon oxide (silica, SiO₂), silicon nitride (SiN), aluminum nitride (AlN), and silicon carbide (SiC), for example. The oxide glass and the oxide glass ceramics are the same as the oxide glass and the oxide glass ceramics contained in the solid electrolyte layer 21, respectively.

(Positive Electrode Terminal and Negative Electrode Terminal)

The positive electrode terminal 26A and the negative electrode terminal 26B contain conductive grains and oxide glass. The conductive grains are the same as the conductive grains contained in the positive electrode collector layer 22B and the negative electrode collector layer 23B described above.

[Method for Manufacturing Battery]

Next, an example of a method for manufacturing a battery according to the second embodiment of the present invention will be described.

(Formation Process of Positive Electrode Layer Precursor, Negative Electrode Layer Precursor, and Solid Electrolyte Layer Precursor)

A positive electrode green sheet, a negative electrode green sheet, and a solid electrolyte green sheet are obtained in the same manner as in the first embodiment.

(Formation Process of Insulation Layer Precursor)

First and second insulation green sheets as precursors of the insulation layers 24B and 25B are formed in the following manner. First, an insulation grain, oxide glass or oxide glass ceramics, and an organic binder are mixed to prepare a mixture powder, and then this mixture powder is dispersed in a solvent, thereby obtaining a slurry as an insulation green sheet forming composition. The first and second insulation green sheets are obtained in the same manner as the above-mentioned “Formation Process of Positive Electrode Layer Precursor” in the first embodiment except for using this slurry.

Third and fourth insulation green sheets as precursors of the insulation layers 24B and 25B are obtained in the same manner as the first and second insulation green sheets described above. The thickness of each of the first to fourth insulation green sheets is set according to a desired thickness of the insulation layers 24A, 24B, 25A, and 25B.

(Formation Process of Positive Electrode Collector Layer Precursor)

The positive electrode collector green sheet as a positive electrode collector layer precursor is formed in the following manner. First, a conductive grain, oxide glass or oxide glass ceramics, and an organic binder are mixed to prepare a mixture powder, and then this mixture powder is dispersed in a solvent, thereby obtaining a slurry as a positive electrode collector green sheet forming composition. The positive electrode collector green sheet is obtained in the same manner as the above-mentioned “Formation Process of Positive Electrode Layer Precursor” in the first embodiment except for using this slurry.

(Formation Process of Negative Electrode Collector Layer Precursor)

The negative electrode collector green sheet as a negative electrode collector layer precursor can be obtained in the same manner as the “Formation Process of Positive Electrode Collector Layer Precursor” described above.

(Lamination and Firing Process of Precursor)

Using each of the green sheets obtained as described above, a battery is produced as follows. First, the positive electrode green sheet, the negative electrode green sheet, the solid electrolyte green sheet, and the first and second insulation green sheets are punched into a rectangular shape having a predetermined size. The third and fourth insulation green sheets are punched into a U shape having a predetermined size.

Next, the first insulation green sheet, the positive electrode collector green sheet, the positive electrode green sheet, the solid electrolyte green sheet, the negative electrode green sheet, and the second insulation green sheet punched into a rectangular shape are laminated in this order to form the laminate 20. At this time, the third insulation green sheet is arranged between the peripheral portions of the main surfaces of the first insulation green sheet and the solid electrolyte green sheet so that the side surfaces of the positive electrode collector green sheet and the positive electrode green sheet are exposed from the side of the first side surface 20Sa of the laminate 20. Also, the fourth insulation green sheet is arranged between the peripheral portions of the main surfaces of the second insulation green sheet and the solid electrolyte green sheet so that the side surfaces of the negative electrode collector green sheet and the negative electrode green sheet are exposed from the side of the second side surface 20Sb of the laminate 20.

The laminate 20 is obtained by performing the subsequent process in the same manner as the “Lamination and Firing Process of Precursor” in the first embodiment.

(Terminal Creation Process)

After applying a conductive paste to the first and second side surfaces 20Sa and 20Sb of the fired laminate 20, the laminate 20 is fired again. Thus, the target battery having the positive electrode terminal 26A and the negative electrode terminal 26B is obtained.

[Effects]

In the battery according to the second embodiment, the circumference of the laminate 20 is covered with the insulation layers 24A, 24B, 25A, and 25B. Accordingly, the safety of the battery can be improved. In addition, the durability of the battery can also be improved because the insulation layers 24A, 24B, 25A and 25B also have a function of suppressing moisture intrusion into the laminate 20.

### 3 Third Embodiment

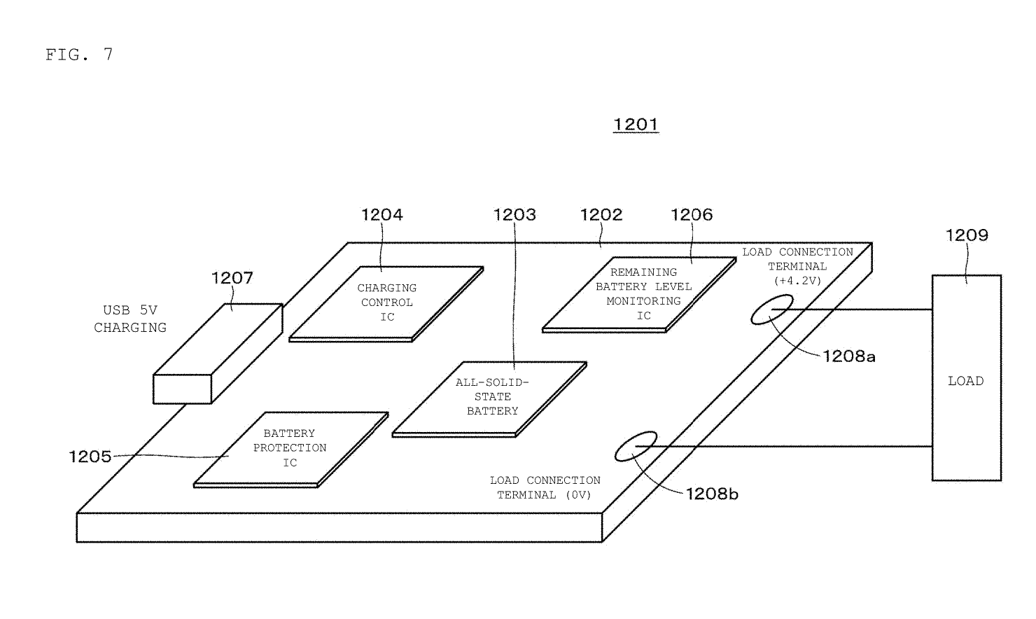

As shown in FIG. 5, the battery according to the third embodiment of the present invention is different from the battery according to the second embodiment in that a laminate 20A is included instead of the laminate 20. In the third embodiment, the same portions as those in the second embodiment are denoted by the same reference numerals.

The laminate 20A has a structure in which the insulation layer 24B, the positive electrode 22, the solid electrolyte layer 21, a negative electrode 23C, the solid electrolyte layer 21, a positive electrode 22C, the solid electrolyte layer 21, the negative electrode 23C, the solid electrolyte layer 21, the positive electrode 22, the solid electrolyte layer 21, the negative electrode 23, and the insulation layer 25B are laminated in this order.

The side surface of the laminate 20A is covered with the insulation layers 24A, 24C, 25A and 25C. More specifically, the side surfaces of the positive electrodes 22 and 22C are covered with the insulation layers 24A and 24C, respectively, so that side surfaces of the positive electrodes 22 and 22C are exposed from the side of the first side surface 20Sa. The side surfaces of the positive electrodes 22 and 22C exposed from the first side surface 20Sa are in contact with the positive electrode terminal 26A. The side surfaces of the negative electrodes 23 and 23C are covered with the insulation layers 25A and 25C so that the side surfaces of the negative electrodes 23 and 23C are exposed from the side of the second side surface 20Sb. The side surfaces of the positive electrodes 22 and 22C exposed from the second side surface 20Sb are in contact with the negative electrode terminal 26B.

The positive electrode 22C includes the positive electrode collector layer 22B, the positive electrode layer 22A provided on one main surface of the positive electrode collector layer 22B, and the positive electrode layer 22A provided on the other main surface of the positive electrode collector layer 22B. The negative electrode 23 includes the negative electrode collector layer 23B, the negative electrode layer 23A provided on one main surface of the negative electrode collector layer 23B, and the negative electrode layer 23A provided on the other main surface of the negative electrode collector layer 23B. The insulation layers 24C and 25C are the same as the insulation layers 24A and 25A, respectively, except in that they have thicknesses that cover the three side surfaces of the positive electrode 22C and the negative electrode 23C.

[Effects]

In the third embodiment, since the battery includes the plurality of laminated positive electrodes 22 and 22C and negative electrodes 23 and 23C, the capacity of the battery can be improved.

### EXAMPLES

Hereinafter, the present invention will be specifically described with reference to examples, but the present invention is not limited only to these examples.

### Example 1

(Production Process of Electrolyte Layer Precursor)

First, an oxide glass containing Li₂O, SiO₂, B₂O₃, and WO₃ in a mole fraction of Li₂O:SiO₂:B₂O₃:WO₃=69.65 mol %:12.66 mol %:14.77 mol %:2.91 mol % was prepared as a solid electrolyte. Next, the oxide glass and an acrylic binder were mixed in a mass ratio of oxide glass:acrylic binder=70:30. Next, this mixture was mixed with butyl acetate so as to have a solid content of 30% by mass and stirred with zirconia balls of 5 mmΦ for 4 hours, thereby obtaining a slurry. Next, this slurry was applied on a mold releasing film and dried at 80° C. for 10 minutes, thereby forming a green sheet on the mold releasing film. Next, the green sheet was punched into a disk shape together with the mold releasing film, and then the green sheet was peeled off from the mold releasing film. As a result, the solid electrolyte green sheet as a solid electrolyte layer precursor was obtained.

(Firing Process of Electrolyte Layer Precursor)

First, the solid electrolyte green sheet was heated at 300° C. for 10 hours to remove the acrylic binder and then sintered at 330° C. for 30 minutes. Thus, an electrolyte layer of 300 μm in thickness was obtained.

### Example 2

An electrolyte layer of 300 μm in thickness was obtained in the same manner as in Example 1 except that an oxide glass containing Li₂O, SiO₂, and B₂O₃ in a mole fraction of Li₂O:SiO₂:B₂O₃=60 mol %:20 mol %:20 mol % was prepared as a solid electrolyte.

### Example 3

An electrolyte layer of 300 μm in thickness was obtained in the same manner as in Example 1 except that an oxide glass containing Li₂O, B₂O₃, and WO₃ in a mole fraction of Li₂O:B₂O₃:WO₃=60 mol %:35 mol %:5 mol % was prepared as a solid electrolyte.

### Example 4

An electrolyte layer of 300 μm in thickness was obtained in the same manner as in Example 1 except that an oxide glass containing Li₂O, SiO₂, B₂O₃, and WO₃ in a mole fraction of Li₂O:SiO₂:B₂O₃: WO₃=50 mol %:10 mol %:35 mol %:5mol % was prepared as a solid electrolyte.

### Example 5

An electrolyte layer of 300 μm in thickness was obtained in the same manner as in Example 1 except that an oxide glass containing Li₂O, B₂O₃, and WO₃ in a mole fraction of Li₂O:B₂O₃:WO₃=50 mol %:45 mol %:5 mol % was prepared as a solid electrolyte.

### Comparative Example 1

An electrolyte layer of 300 μm in thickness was obtained in the same manner as in Example 1 except that an oxide glass containing Li₂O, SiO₂, and B₂O₃ in a mole fraction of Li₂O:SiO₂:B₂O₃32 54 mol %:11 mol %:35 mol % was prepared as a solid electrolyte.

### Comparative Example 2

An electrolyte layer of 300 μm in thickness was obtained in the same manner as in Example 1 except that an oxide glass containing Li₂O, SiO₂, and B₂O₃ in a mole fraction of Li₂O:SiO₂:B₂O₃=70.83 mol %:16.67 mol %:12.5 mol % was prepared as a solid electrolyte.

(Evaluations)

The following evaluations were conducted using the electrolyte layers of Examples 1 to 5 and Comparative Examples 1 and 2 obtained as described above as evaluation samples.

(DTA Curve)

By differential thermal analysis, the differential thermal analysis (DTA) curve of the evaluation samples was obtained as follows.

First, using TG-DTA measuring device (DTG-60/60H) manufactured by Shimadzu Corporation, the evaluation samples were heated at a rate of 10° C./min in a nitrogen flow to obtain a DTA curve. Next, the rising temperature Ta of the exothermic peak was calculated from the obtained DTA curve.

(X-Ray Diffraction)

X-ray diffraction with CuKα as a radiation source was performed using SmartLab (3 kw) manufactured by Rigaku Corporation, and it was confirmed whether the state of the evaluation samples had changed from glass to glass ceramics at the exothermic peak. As a result, in each of the evaluation samples, it was confirmed that the state of the evaluation sample had changed from glass to glass ceramics at the exothermic peak.

(Reduction Rate of Ionic Conductivity)

The ionic conductivity of the evaluation samples was obtained by the AC impedance method as follows. First, a current collector is formed by depositing platinum on both surfaces of the evaluation sample by sputtering so as to have a thickness of 3 mmφ. Next, the sample was sandwiched between the jigs prepared using SUS304, and AC impedance was measured (frequency: 10⁺⁶ Hz to 10⁻¹ Hz, Voltage: 10 mV, 100 mV, 1000 mV) using the impedance measuring device (Solartron 1260, manufactured by Toyo Technica Co.) while the temperature of the heating stage was adjusted so that the sample reached a predetermined temperature on the heating stage, thereby creating a Cole-Cole plot. Subsequently, the ionic conductivity was obtained from this Cole-Cole plot. Next, using the obtained ionic conductivity, the reduction rate in ionic conductivity was obtained from the formula (1) described above.

(Results)

Table 1 shows the structure and evaluation results of the solid electrolyte layers of Examples 1 to 5 and Comparative Examples 1 and 2.

TABLE 1

| | | | Ionic |
|---|---|---|---|
| | | Rising | conductivity |
| | | temperature | reduction |
| | Electrolyte composition | Ta | rate |
| | (molar ratio) | (° C.) | (%) |
| Example 1 | [Li₂O]/[SiO₂]/[B₂O₃]/[WO₃] = 69.65/12.66/14.77/2.91 | 346 | 90.5 |
| Example 2 | [Li₂O]/[SiO₂]/[B₂O₃] = 60/20/20 | 378 | 94.4 |
| Example 3 | [Li₂O]/[B₂O₃]/[WO₃] = 60/35/5 | 387 | 86.7 |
| Example 4 | [Li₂O]/[SiO₂]/[B₂O₃]/[WO₃] = 50/10/35/5 | 511 | 88.8 |
| Example 5 | [Li₂O]/[B₂O₃]/[WO₃] = 50/45/5 | 481 | 92.2 |
| Comparative | [Li₂O]/[SiO₂]/[B₂O₃] = 54/11/35 | 453 | −38 |
| example 1 | | | |
| Comparative | [Li₂O]/[SiO₂]/[B₂O₃] = 70.83/16.67/12.5 | 368 | −158 |
| example 2 | | | |

FIG. 6 shows the temperature dependence of the ionic conductivity and the DTA curve of Example 3 as a representative. FIG. 6 indicates that the solid electrolyte layer of Example 3 has the rising temperature Ta of the exothermic peak due to recrystallization within the range of 350° C. to 550° C. and the ionic conductivity on the side of the temperature higher than the rising temperature Ta of the exothermic peak in the temperature rising process is greatly lower than the ionic conductivity on the side of the temperature lower than the rising temperature Ta of the exothermic peak in the temperature rising process.

Table 1 indicates that the solid electrolyte layers of Examples 1, 2, 4, and 5 also have the same characteristics as those of the solid electrolyte layer of Example 3 described above. On the other hand, the solid electrolyte layers in Comparative Examples 1 and 2 have the rising temperature Ta of the exothermic peak due to recrystallization within the range of 350° C. to 550° C. but the ionic conductivity on the side of the temperature higher than the rising temperature Ta of the exothermic peak is higher than the ionic conductivity on the side of the temperature lower than the rising temperature Ta of the exothermic peak.

Table 1 also indicates the following. The reduction rate in the ionic conductivity is 85% or more in the solid electrolytes of Examples 3 and 4, the reduction rate in the ionic conductivity is 90% or more in the solid electrolytes of Examples 1 and 5, and the reduction rate in the ionic conductivity is 94% or more in the solid electrolyte of Example 2. Accordingly, from the viewpoint of the shutdown function, the solid electrolytes of Examples 1 and 5 are preferable, and the solid electrolyte of Example 2 is more preferable.

### Application Examples

“Printed Circuit Board as Application Example”

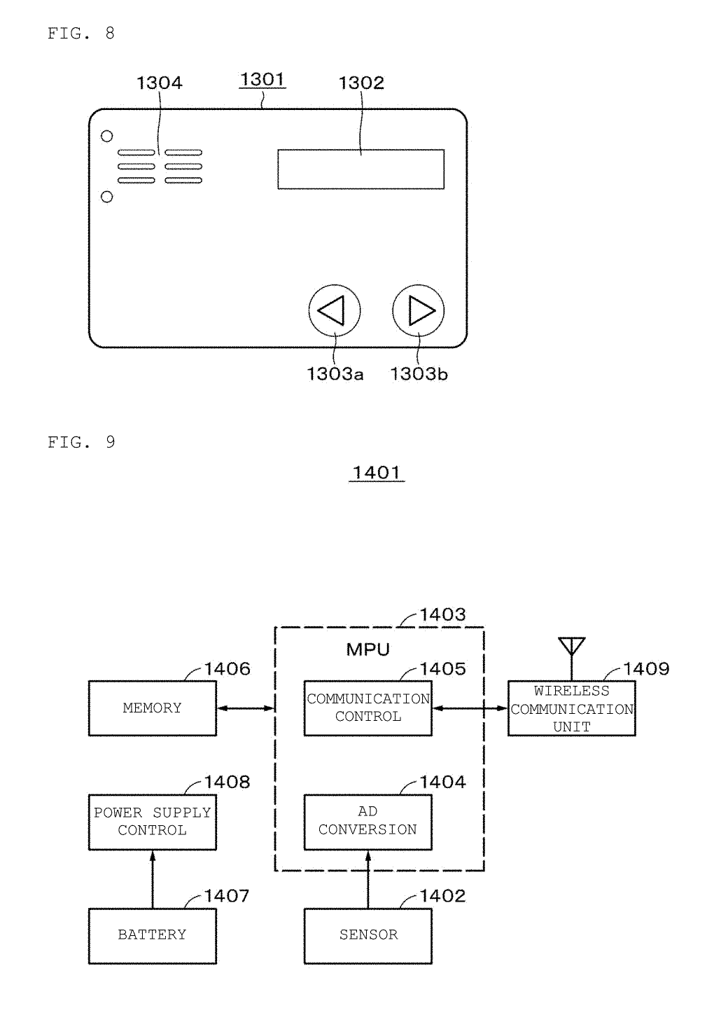

Hereinafter, an application example will be described in which the present invention is applied to a printed circuit board. As shown in FIG. 7, the all-solid-state battery described above can be mounted on a printed circuit board 1202 together with a charging circuit and the like. For example, an all-solid-state battery 1203 and an electronic circuit such as a charging circuit can be mounted on the printed circuit board 1202 by a reflow process. The printed circuit board 1202 on which the all-solid-state battery 1203 and the electronic circuit such as a charging circuit are mounted is referred to as a battery module 1201. The battery module 1201 is configured as a card shape where necessary, and can be configured as a portable card type mobile battery.

The all-solid-state battery 1203 is formed on the printed circuit board 1202. A charge control integrated circuit (IC) 1204, a battery protection IC 1205, and a remaining battery level monitoring IC 1206 are formed as they share the printed circuit board 1202. The battery protection IC 1205 controls the charge and discharge operation so as to prevent a charging voltage from becoming excessive at the time of charge and discharge, an overcurrent from flowing due to a load short circuit, and an overdischarge from occurring.

A USB (Universal Serial Bus) interface 1207 is attached to the printed circuit board 1202. The all-solid-state battery 1203 is charged by electric power supplied through the USB interface 1207. In this case, the charging operation is controlled by the charge control IC 1204. Further, a predetermined electric power (for example, voltage is 4.2V) is supplied to a load 1209 from load connection terminals 1208a and 1208b attached to the printed circuit board 1202. The remaining battery level of the all-solid-state battery 1203 is monitored by the remaining battery level monitoring IC 1206 so that a display (not illustrated) indicative of the battery remaining level can be recognized from the outside. The USB interface 1207 may be used for load connection.

Specific examples of the above-described load 1209 are as follows.

Wearable devices (sports watches, watches, hearing aids, and the like)

IoT terminals (sensor network terminals and the like)

Amusement devices (handheld game console terminals and game controllers)

IC board embedded batteries (real-time clock IC)

Environmental power generation devices (power storage elements for power generation elements such as photovoltaic power generation, thermoelectric power generation, and vibration power generation)

“Universal Credit Card as Application Example” Hereinafter, an application example will be described in which the present invention is applied to a universal credit card.

Currently, many people carry a plurality of credit cards. There is a problem that the more credit cards they have, the higher the risk of loss, theft, and the like become. Therefore, a card called a universal credit card in which functions of a plurality of credit cards, loyalty cards, and the like are integrated in a single card has been put into practical use. Information of, for example, card numbers and expiration dates of various credit cards and loyalty cards and the like can be integrated in this card. Thus, if such a single card is put into a wallet or the like, the users can select and use whatever cards they like anytime.

FIG. 8 shows an example of the configuration of a universal credit card 1301. It is shaped into a card and has a built-in IC chip and a built-in all-solid-state battery according to the present invention. In addition, it is provided with a display 1302 with low power consumption and operating portions such as arrow keys 1303a and 1303b. Further, a charging terminal 1304 is provided on the surface of the universal credit card 1301.

The user can specify a credit card or the like loaded in advance in the universal credit card 1301 by operating the arrow keys 1303a and 1303b while viewing the display 1302, for example. If a plurality of credit cards are loaded in advance, information indicative of each credit card is displayed on the display 1302, and the user can designate a desired credit card by operating the arrow keys 1303a and 1303b. After that, it can be used similar to a conventional credit card. It is to be noted that the above is just an example and that the all-solid-state battery according to the present invention can obviously be applied to any electronic card other than the universal credit card 1301.

“Sensor Network Terminal as Application Example”

Hereinafter, an application example in which the present invention is applied to a sensor network terminal will be described.

A wireless terminal in a wireless sensor network is called a sensor node, and is composed of one or more wireless chips, a microprocessor, a power supply (battery), and the like. Specific examples of use of the sensor network include monitoring of energy saving management, healthcare, industrial measurement, traffic situation, agriculture, and the like. Voltage, temperature, gas, illuminance, and the like are used as the type of the sensor.

In a case of energy saving management, a power monitor node, a temperature/humidity node, an illuminance node, a CO₂ node, a human motion node, a remote control node, a router (repeater), and the like are used as a sensor node. These sensor nodes are provided so as to constitute a wireless network in homes, office buildings, factories, shops, amusement facilities, and the like.

Data such as temperature, humidity, illuminance, CO₂ concentration, electric energy, and the like are displayed, and the situation of energy saving of the environment is made visible. Furthermore, on/off control of lighting, air conditioning facility, ventilation facility, and the like are performed by a command from the control station.

ZigBee (registered trademark) can be used as one of the wireless interfaces of the sensor network. This wireless interface is one of the short-distance wireless communication standards, and has a feature of inexpensiveness and small power consumption in exchange for a short transferable distance and a low transfer speed. Accordingly, it is suitable to be mounted in a battery-powered device. The basic part of this communication standard is standardized as IEEE 802.15.4. ZigBee (registered trademark) Alliance develops specifications for communication protocols between devices of the logical layer and higher.

FIG. 9 shows the configuration of an example of a wireless sensor node 1401. A detection signal of a sensor 1402 is supplied to an AD conversion circuit 1404 of a microprocessor (MPU) 1403. The various sensors described above can be used as the sensor 1402.

A memory 1406 is provided in association with the microprocessor 1403.

Further, output of a battery 1407 is supplied to a power supply control unit 1408, and the power supply of the wireless sensor node 1401 is managed. The above-mentioned all-solid-state battery, a card type battery pack, or the like can be used as the battery 1407.

A program is installed in the microprocessor 1403.

The microprocessor 1403 processes data of detection results of the sensor 1402 output from the AD conversion circuit 1404 according to the program. A wireless communication unit 1409 is connected to a communication control unit 1405 of the microprocessor 1403. Detection result data are transmitted from the wireless communication unit 1409 to a network terminal (not illustrated), e.g., using ZigBee (registered trademark) and the microprocessor 1403 is connected to the network via the network terminal. A predetermined number of wireless sensor nodes can be connected to one network terminal. Available network topology includes the tree, the mesh, and the linear, in addition to the star.

“Wristband Type Electronic Device as Application Example”

Hereinafter, an application example in which the present invention is applied to a wristband type electronic device will be described.

An example of wearable terminals is wristband type electronic devices. Among them, the wristband type activity meter, which is also called the smart band, is capable of acquiring data on human activities such as the number of steps, travel distance, calorie consumption, amount of sleep, and heart rate, when simply wrapped around the arm. Further, the acquired data can be managed by the smartphone. Further, it is also possible to include a mail transmission/reception function. For example, those with a notification function of notifying the user of an incoming mail by an LED (Light Emitting Diode) lamp and/or vibrating is used.

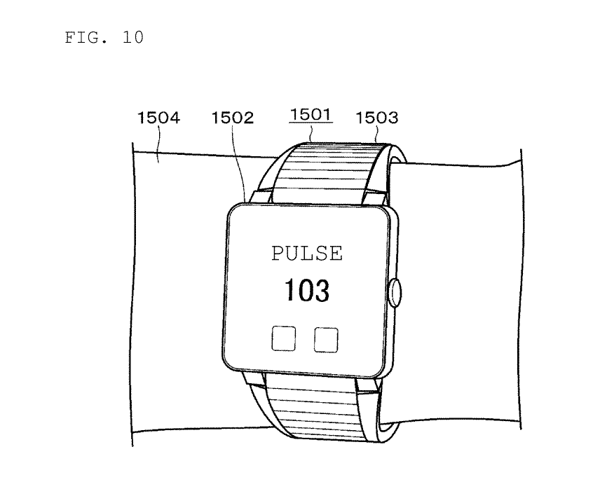

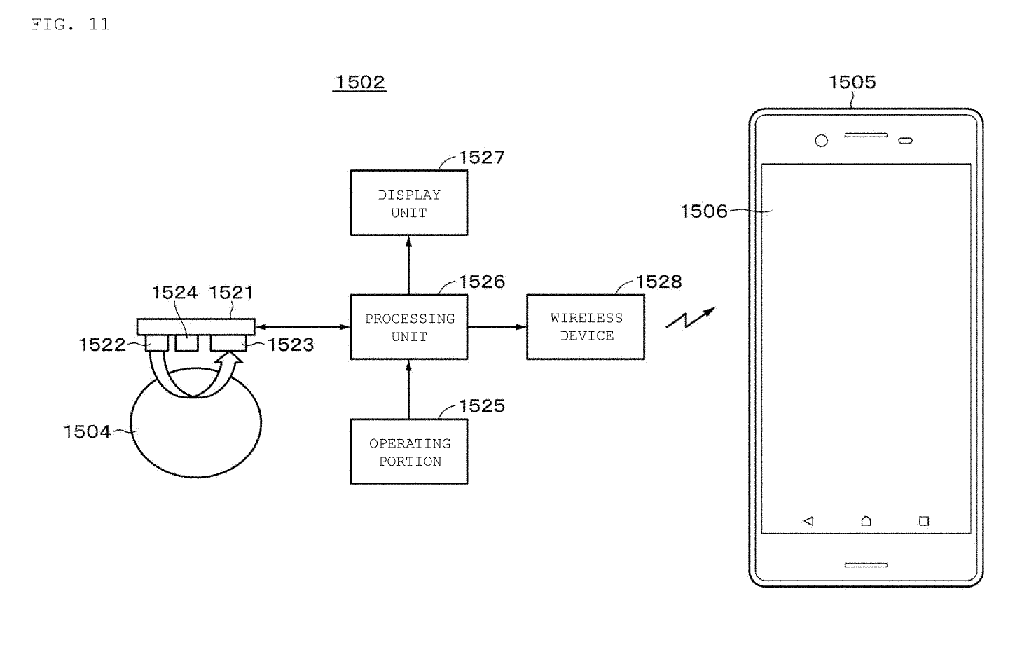

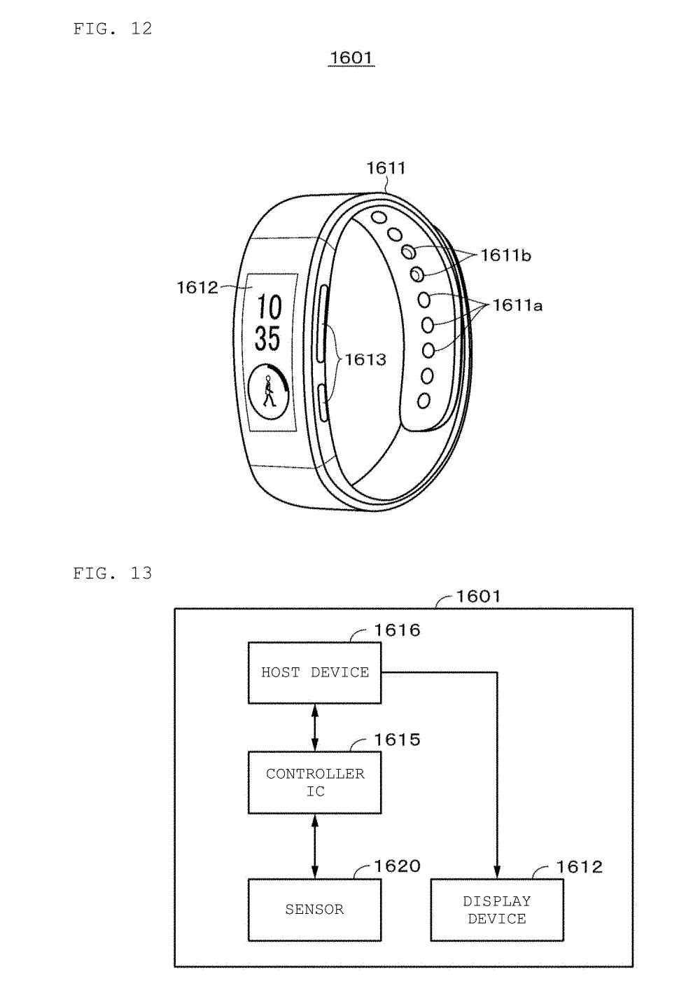

FIG. 10 and FIG. 11 show an example of wristband type activity meters for measuring a pulse, for example. FIG. 10 shows a configuration example of the appearance of a wristband type activity meter 1501. FIG. 11 shows a configuration example of a main body portion 1502 of the wristband type activity meter 1501.

The wristband type activity meter 1501 is a wristband type measurement device for measuring, for example, the pulse of a test subject in an optical manner. As shown in FIG. 10, the wristband type activity meter 1501 is composed of the main body portion 1502 and a band 1503 and, similarly to a watch, the band 1503 is worn on an arm (wrist) 1504 of a test subject. Then, the main body portion 1502 irradiates a site of the arm 1504 of the test subject including the pulse with measurement light having a predetermined wavelength, and, based on the intensity of the returning light, measures the pulse of the test subject.

The main body portion 1502 is configured to include a board 1521, an LED 1522, a light-receiving integrated circuit (IC) 1523, a light-shielding body 1524, an operating portion 1525, a processing unit 1526, a display unit 1527, and a wireless device 1528. The LED 1522, the light-receiving IC 1523, and the light-shielding body 1524 are provided on the board 1521. Under the control of the light-receiving IC 1523, the LED 1522 irradiates the site of the arm 1504 of the test subject including the pulse with measurement light having a predetermined wavelength.

The light-receiving IC 1523 receives the light returning after the measurement light is irradiated onto the arm 1504. The light-receiving IC 1523 generates a digital measurement signal indicative of the intensity of returned light and supplies the generated measurement signal to the processing unit 1526.

The light-shielding body 1524 is provided between the LED 1522 and the light-receiving IC 1523 on the board 1521. The light-shielding body 1524 prevents measurement light from the LED 1522 from directly entering the light-receiving IC 1523.

The operating portion 1525 is composed of various operation members such as buttons and switches, for example, and is provided on the surface of the main body portion 1502 or the like. The operating portion 1525 is used for operating the wristband type activity meter 1501 and supplies a signal indicative of the operation content to the processing unit 1526.

The processing unit 1526 performs arithmetic processing for measuring the pulse of the test subject based on the measurement signal supplied from the light-receiving IC 1523. The processing unit 1526 supplies the measurement result of the pulse to the display unit 1527 and the wireless device 1528.

The display unit 1527 is constituted by a display device such as an LCD (Liquid Crystal Display), for example, and is provided on the surface of the main body portion 1502. The display unit 1527 displays the measurement result of the pulse of the test subject and the like.

The wireless device 1528 transmits the measurement result of the pulse of the test subject to an external device by wireless communication of a predetermined method. For example, as shown in FIG. 11, the wireless device 1528 transmits the measurement result of the pulse of the test subject to a smartphone 1505, and displays the measurement result on a screen 1506 of the smartphone 1505. Further, data of the measurement result are managed by the smartphone 1505, and the measurement result can be viewed using the smartphone 1505 and can be stored in a server on the network. An arbitrary method can be adopted as the communication method of the wireless device 1528. Note that the light-receiving IC 1523 can also be used to measure the pulse at a site (e.g., a finger, an earlobe, or the like) other than the arm 1504 of the test subject.

The above-described wristband type activity meter 1501 is capable of accurately measuring the pulse wave and the pulse of the test subject by removing the influence of body motion by signal processing in the light-receiving IC 1523. For example, even if the test subject works out vigorously such as running, it is possible to accurately measure the pulse wave and the pulse of the test subject. For example, even when the measurement is performed with the wristband type activity meter 1501 being worn on the test subject for a long time, it is possible to keep accurately measuring the pulse wave and the pulse by removing the influence of the body motion of the test subject.

Further, reduction in the amount of calculation allows the power consumption of the wristband type activity meter 1501 to be reduced. As a result, it becomes possible to perform the measurement with the wristband type activity meter 1501 being worn on the test subject for a long time without charging or replacing the battery, for example.

As a power supply, for example, a thin battery is housed in the band 1503. The wristband type activity meter 1501 includes an electronic circuit of the main body and a battery pack. For example, the battery pack is configured to be detachable and attachable by the user. The electronic circuit is a circuit included in the above-described main body portion 1502. The present invention can be applied when an all-solid-state battery is used.

FIG. 12 and FIG. 13 show another example of a wristband type electronic device. FIG. 12 shows a configuration example of the appearance of a wristband type electronic device 1601. FIG. 13 is a configuration block diagram of the wristband type electronic device 1601 (hereinafter simply referred to as the “electronic device 1601”).

The electronic device 1601 is, for example, a so-called wearable device that is a watch type detachable from and attachable to the human body. The electronic device 1601 includes, for example, a band portion 1611 to be worn on the arm, a display device 1612 that displays numerals, characters, symbols, and the like, and operation buttons 1613. The band portion 1611 is provided with a plurality of hole portions 1611a and protrusions 1611b formed on the inner peripheral surface (the surface in contact with the arm when the electronic device 1601 is worn) side.

When in use, the electronic device 1601 is bent so that the band portion 1611 becomes substantially circular as shown in FIG. 12, the protrusions 1611b are inserted into the hole portions 1611a , and thus the electronic device 1601 is worn on the arm. By adjusting the position of the hole portions 1611a into which the protrusions 1611b are inserted, the size of the diameter can be adjusted corresponding to the arm thickness. When the electronic device 1601 is not in use, the protrusions 1611b are removed from the hole portions 1611a, and the band portion 1611 is stored in a substantially flat state. The sensor according to an embodiment of the present invention is provided over the entire band portion 1611, for example.

FIG. 13 is a block diagram showing a configuration example of the electronic device 1601. As shown in FIG. 13, the electronic device 1601 includes a sensor 1620 including a controller IC 1615 as a drive control unit and a host device 1616, in addition to the above-described display device 1612. The sensor 1620 may include the controller IC 1615.

The sensor 1620 is capable of detecting both pressing and bending. The sensor 1620 detects a change in electrostatic capacity in response to pressing and outputs to the controller IC 1615 an output signal corresponding to the change. Further, the sensor 1620 detects a change (resistance change) in the resistance value in response to bending and outputs to the controller IC 1615 an output signal corresponding to the change.

The host device 1616 executes various processing based on information supplied from the controller IC 1615. For example, it executes processing such as display of character information, image information, and the like on the display device 1612, movement of a cursor displayed on the display device 1612, and scrolling of the screen.

The display device 1612 is, for example, a flexible display device that displays an image (screen) based on a video signal, a control signal, and the like supplied from the host device 1616. Examples of the display device 1612 include a liquid crystal display, an electro luminescence (EL) display, and an electronic paper, but it is not limited thereto.

As a power supply, for example, a thin battery and the electronic circuit shown in FIG. 13 are housed in the band portion 1611. The electronic device 1601 includes an electronic circuit of the main body and a battery pack. For example, the battery pack is configured to be detachable and attachable by the user. The present invention can be applied when an all-solid-state battery is used.

“Smartwatch as Application Example”

Hereinafter, an application example in which the present invention is applied to a smartwatch will be described.

This smartwatch has an appearance same as or similar to the design of the existing watches and is worn on the user's arm similarly to the watch when used. The smartwatch has a function of notifying the user of various messages such as an incoming call and e-mail, which is information to be displayed on the display. Moreover, smartwatches having an electronic money function and functions such as activity meter have been proposed. In the smartwatch, the display is incorporated on the surface of the main body portion of the electronic device, and various information is displayed on the display. Further, the smartwatch is capable of cooperating with functions, contents, and the like of the communication terminal or the like by performing short-distance wireless communication with a communication terminal (a smartphone or the like), such as Bluetooth (registered trademark), for example.

One of the smartwatches that have been proposed has a plurality of segments coupled in a band shape, a plurality of electronic components arranged in the plurality of segments, and a flexible circuit board that connects the plurality of electronic components in the plurality of segments and is arranged in a meandering shape in at least one segment. Such a meandering shape prevents stress from being applied to the flexible circuit board even if the band is bent, and prevents the flexible circuit board from being cut. Further, electronic circuit parts can be built in the band side segments attached to the watch main body, not to the chassis constituting the watch main body. It is not necessary to change the watch main body side and it is possible to configure a smartwatch having the same design as the design of the conventional watch.

Next, the configuration of the smartwatch will be described in more detail. The portion corresponding to the band of a common watch serves as the main body of the smartwatch in this application example. That is, the band (belt) alone works as an electronic device. In other words, the conventional watch can be used as it is as the watch main body displaying the time with hands or the like. A band type electronic device attached to the watch main body has a communication function and a notification function that are built therein. The smartwatch of this application example is capable of performing notification such as e-mails and incoming calls, record of logs of user's action history, call, and the like. In addition, the smartwatch includes a function as a contactless IC card, and is capable of performing settlement, authentication, and the like in a contactless manner.

The smartwatch of this application example has circuit components for performing communication processing and notification processing built in a metallic band. In order to function as an electronic device while reducing the thickness of the metallic band, the band has a structure in which the plurality of segments are coupled, and a circuit board, a vibration motor, a battery, and an acceleration sensor are housed in each of the segments. The components such as the circuit board, the vibration motor, the battery, and the acceleration sensor of each of the segments are connected via a flexible printed circuit board (hereinafter referred to as an “FPC”). However, there is a problem that if the band having the built-in FPC to which each component is connected is bent in a circular shape, stress is applied to the wiring of the FPC, and the wiring of the FPC breaks. While this can be solved by providing a meandering shape as described later, another problem arises that the waterproof property of the inside of the band fails to be ensured. There is yet another problem that if the antenna is arranged in the metallic band, radio waves do not go out of the band. Furthermore, since it is normally impossible to arrange the FPC in the buckle mechanism for fastening the band, it is difficult to make an electrical connection in front of and behind the portion of the buckle mechanism.

That is, in order to incorporate an electronic device in a metallic band, it is necessary to solve the following three problems.

Problem of FPC Wiring and Waterproof

Problem of Antenna with Metal Chassis

Problem of Buckle Mechanism and Electrical Contact

The outline of the configuration for solving these three problems will be described below.

Configuration to solve the problem of FPC wiring and waterproof

When arranging the components of the electronic device in each of the segments, it is necessary to connect between the segments with the FPC. However, when the metallic band is bent so as to be attached to the user's arm, stress is applied to the outside of the FPC, which may cause the FPC to break. Therefore, the meandering shape is provided to prevent the FPC from breaking. In addition, since the electronic device of this application example is a smartwatch to be attached to a watch, it is necessary to provide a meandering shape while realizing waterproofing. Therefore, in this application example, a small segment called “mating component”, which is a component unique to a watch band, is prepared between the segments.

In a space of the small segment, the FPC has a meandering shape. The meandering shape may have any shape such as an S shape, a V shape, a U shape, a Z shape, a curved shape, a semicircular shape, and a polygonal line shape. By doing so, even if the metallic band is bent, the meandering shape of the FPC is simply extended and the FPC does not break. Furthermore, an entrance of the FPC present in the segment portion is held with a rubber packing (relatively soft resin). Then, the mating portion maintains the waterproof property of each of the segments meanwhile letting the FPC move freely without holding the entrance. The introduction of this “mating portion” can prevent the FPC from breaking meanwhile ensuring the waterproof property of the main body. This “mating portion” can be omitted in the case where the electronic component is completed with merely one component (segment).

b. Problem of Antenna with Metal Chassis

The metal band has a problem that when an antenna is put inside, radio waves from the antenna do not go out. In the present invention, an antenna for Bluetooth (registered trademark) and an antenna for NFC (Near Field Communication) are arranged in a single chassis (component) of a metallic band. In order to prevent the antenna characteristics from being affected by other components, an insulator is sandwiched between the components containing the antenna and other adjacent components.

The whole surface (approximately six surfaces) of the component having the antenna incorporated therein is used as the antenna. However, the antenna characteristics are deteriorated when the component comes in contact with the user's skin, and hence the surface in contact with the user's skin may be made of a material other than metal and not used as the antenna. Further, as another example, an insulation layer may be sandwiched between the metal component to be in contact with the user's skin and a component serving as an antenna. Further, the component with the built-in antenna may be used as a slit antenna by providing it with a slit. The component in which the antenna for Bluetooth (registered trademark) is arranged and the component in which the antenna for NFC is arranged may be different components. Bluetooth (registered trademark) wireless communication performs communication in the 2.4 GHz band. This allows pairing up to approximately 10 m on average when performing wireless communication in a state without obstacle between the smartwatch and the smartphone. The antenna problem can be solved by introducing a method by which the metal chassis itself is used as an antenna.

c. Problem of Buckle Mechanism and Electrical Contact

In the smartwatch of a metallic band, since the board is arranged on the largest component arranged in a position overlapping with the buckle, the buckle becomes thicker than the buckle for the ordinary watch. It is difficult to pass through the FPC inside the buckle. Accordingly, there is a problem that electrical connection cannot be established between one segment and the other segment connected by the buckle.

In this application example, a thinner configuration is realized in which one of the two components constituting the buckle is housed in an empty space of the other component when the buckle is folded. In addition, it is a configuration in which an electrical contact is arranged between one segment and the other segment connected by the buckle.

(Overall Configuration of Smartwatch)

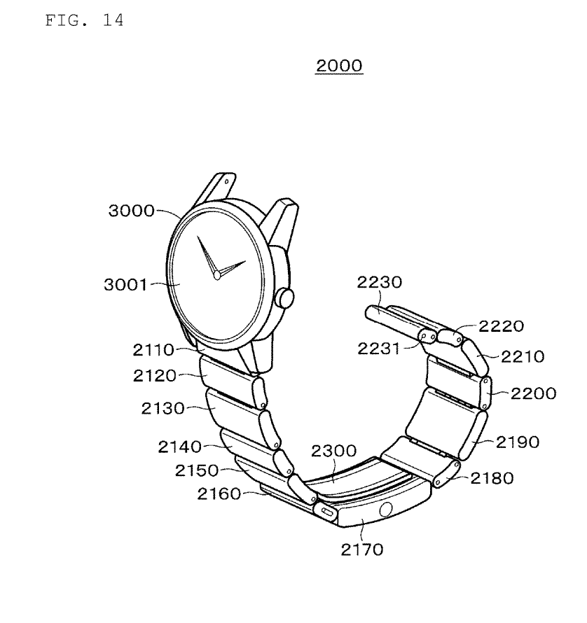

FIG. 14 shows the overall configuration of the smartwatch. A band type electronic device 2000 is a metallic band to be attached to a watch main body 3000, and is worn on the user's arm. The watch main body 3000 includes a dial face 3100 displaying the time. Instead of the dial face 3100, the watch main body 3000 may electronically display the time on a liquid crystal display or the like.

The band type electronic device 2000 has a configuration in which a plurality of segments 2110 to 2230 are coupled. The segment 2110 is attached to one band attachment hole of the watch main body 3000 and the segment 2230 is attached to the other band attachment hole of the watch main body 3000. In this application example, each of the segments 2110 to 2230 is made of metal.

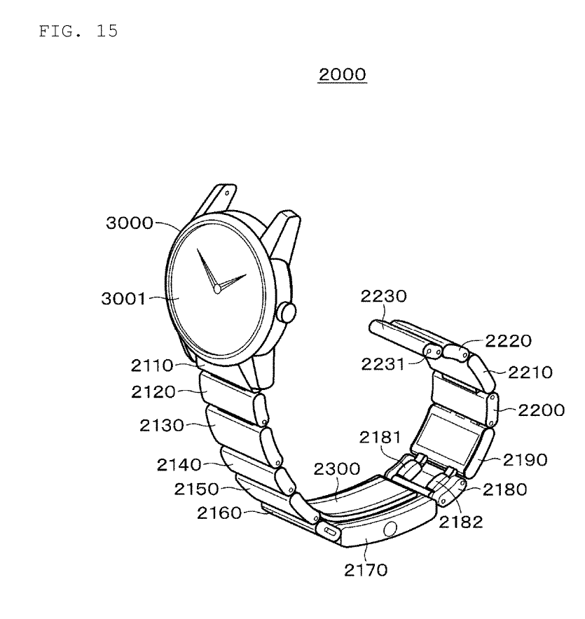

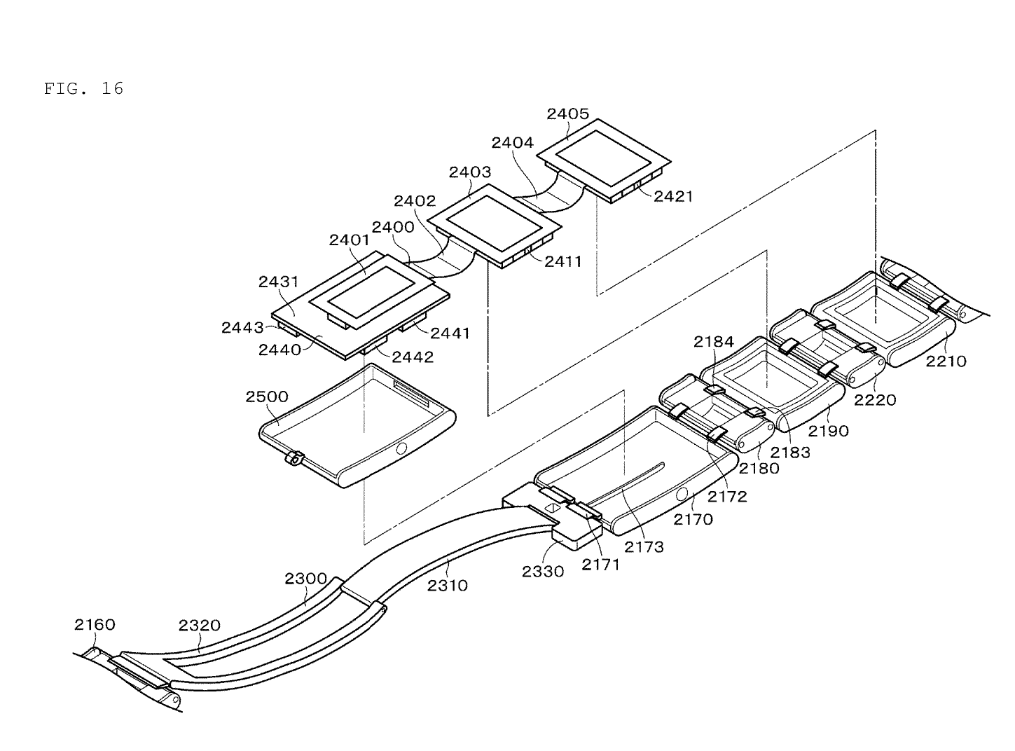

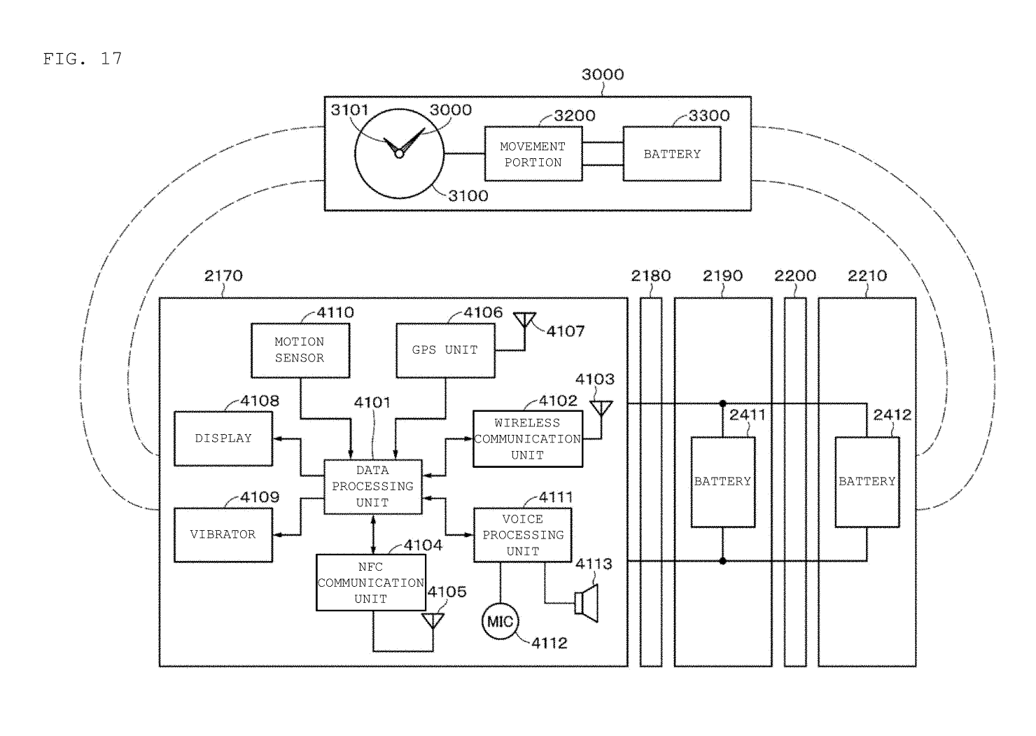

In order to explain the configuration of the band type electronic device 2000, FIG. 14 and FIG. 15 show the state in which the watch main body 3000 and the segment 2230 are separated. However, the segment 2230 is attached to the watch main body 3000 when in actual use. By attaching the segment 2230 to the watch main body 3000, the band type electronic device 2000 can be worn on the user's arm similarly to a normal watch. The connection portion of each of the segments 2110 to 2230 is movable. Since the connection portion of the segment is movable, the band type electronic device 2000 can be fitted to the user's arm.

A buckle portion 2300 is arranged between the segment 2170 and the segment 2160. The buckle portion 2300 elongates when unlocked and shortens when locked. The segments 2110 to 2230 are configured in a plurality of types of size. For example, the segment 2170 connected with the buckle portion 2300 has the largest size.

(Outline of the Inside of the Segment)

FIG. 16 shows a part of the internal configuration of the band type electronic device 2000. For example, the inside of the three segments 2170, 2180, 2190, 2200, and 2210 are shown. In the band type electronic device 2000, a flexible circuit board 2400 is arranged inside of the five consecutive segments 2170 to 2210. Various electronic components are arranged in the segment 2170, and batteries 2411 and 2421 are arranged in the segments 2190 and 2210, respectively. These components are electrically connected via the flexible circuit board 2400. The segment 2180 between the segment 2170 and the segment 2190 has a relatively small size and the meandering flexible circuit board 2400 is arranged therein. Inside of the segment 2180, the flexible circuit board 2400 is arranged in a state of being sandwiched between waterproof members. The inside of the segments 2170 to 2210 has a waterproof structure. The waterproof structure of the segments 2170 to 2210 will be described later.

(Circuit Configuration of Smartwatch)

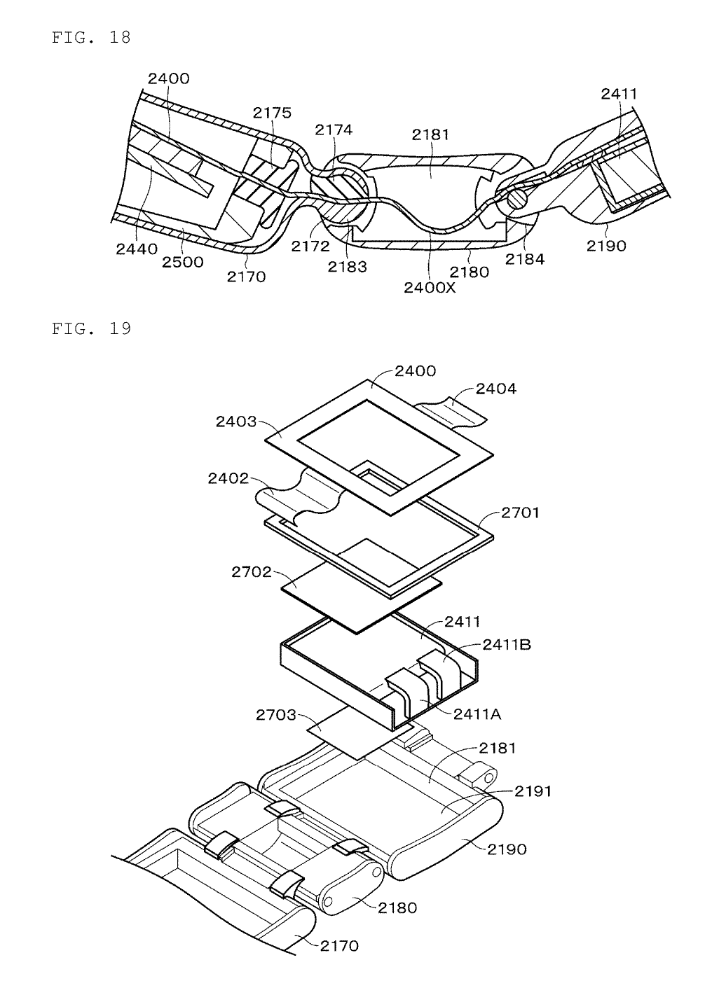

FIG. 17 is a block diagram showing a circuit configuration of the band type electronic device 2000. The circuit inside the band type electronic device 2000 has a configuration independent of the watch main body 3000. The watch main body 3000 includes a movement portion 3200 that rotates the hands arranged on the dial face 3100. A battery 3300 is connected to the movement portion 3200. The movement portion 3200 and the battery 3300 are built in the chassis of the watch main body 3000.

The band type electronic device 2000 connected to the watch main body 3000 includes electronic components that are arranged in the three segments 2170, 2190, and 2210. In the segment 2170, a data processing unit 4101, a wireless communication unit 4102, an NFC communication unit 4104, and a GPS unit 4106 are arranged. Antennas 4103, 4105, and 4107 are connected to the wireless communication unit 4102, the NFC communication unit 4104, and the GPS unit 4106, respectively. The respective antennas 4103, 4105, and 4107 are arranged in the vicinity of a slit 2173 described later of the segment 2170.

The wireless communication unit 4102 performs short-distance wireless communication with other terminals according to the Bluetooth (registered trademark) standard, for example. The NFC communication unit 4104 performs wireless communication with a close reader/writer according to the NFC standard. The GPS unit 4106 is a positioning unit that receives a radio wave from a satellite of a system called GPS (Global Positioning System) to perform positioning of the current position. Data acquired by the wireless communication unit 4102, the NFC communication unit 4104, and the GPS unit 4106 are supplied to the data processing unit 4101.

In the segment 2170, a display 4108, a vibrator 4109, a motion sensor 4110, and a voice processing unit 4111 are arranged. The display 4108 and the vibrator 4109 function as a notification unit that gives notifications to the wearer of the band type electronic device 2000. The display 4108, which includes a plurality of light-emitting diodes, gives notifications to the user by turning on or blinking the light-emitting diodes. The plurality of light-emitting diodes are arranged inside the slit 2173 described later of the segment 2170, for example, and gives notifications of an incoming telephone call, e-mail reception, or the like by turning on or blinking. A type of display that displays characters, numbers, and the like may be used as the display 4108. The vibrator 4109 is a member that vibrates the segment 2170. The band type electronic device 2000 gives notifications of an incoming call, e-mail reception, and the like by the vibrator 4109 vibrating the segment 2170.

The motion sensor 4110 detects the movement of the user wearing the band type electronic device 2000. As the motion sensor 4110, an acceleration sensor, a gyro sensor, an electronic compass, an atmospheric pressure sensor, or the like is used. The segment 2170 may have a built-in sensor other than the motion sensor 4110. For example, it may have a built-in biosensor that detects the pulse or the like of the user wearing the band type electronic device 2000. A microphone 4112 and a speaker 4113 are connected to the voice processing unit 4111, which performs processing of a call with a party connected via wireless communication by the wireless communication unit 4102. The voice processing unit 4111 is further capable of performing processing for a voice input operation.

A battery 2411 is built in the segment 2190, and a battery 2421 is built in the segment 2210. The batteries 2411 and 2421 are composed of, for example, all-solid-state batteries, and supply driving power to the circuit in the segment 2170. The circuit in the segment 2170 and the batteries 2411 and 2421 are connected via the flexible circuit board 2400 (FIG. 16). Although not illustrated in FIG. 17, the segment 2170 includes terminals for charging the batteries 2411 and 2421. Electronic components other than the batteries 2411 and 2421 may be arranged in the segments 2190 and 2210. For example, the segments 2190 and 2210 may include a circuit that controls charging and discharging of the batteries 2411 and 2421.

(Example of Arrangement of Components in Segment)

FIG. 16 shows the configuration of the segments 2170 to 2210 in which electronic components and the like are arranged and the buckle portion 2300 coupled with the segment 2170. The segments 2170 to 2210 are shown with a lid member (not illustrated) opened. The chassis constituting each of the segments 2170 to 2210 is formed of a metal such as stainless steel.

Inside of the segments 2170 to 2210, the flexible circuit board 2400, electronic components mounted to the flexible circuit board 2400, and the like are arranged. FIG. 16 shows a state in which a first member 2310 and a second member 2320 of the buckle portion 2300 are opened. When the first member 2310 and the second member 2320 are closed, the buckle portion 2300 is arranged in a position overlapping the back surface (the upper side in FIG. 16) of the segment 2170.

The segment 2170 is larger in size than the other segments and houses the electronic components shown in FIG. 17. An inner chassis 2500 made of a transparent resin (or translucent resin) is arranged inside the segment 2170, and the flexible circuit board 2400 and the like are arranged in the inner chassis 2500. A coupling portion 2171 on one side of the segment 2170 is coupled with a coupling portion 2330 of the buckle portion 2300. A coupling portion 2172 on the other side of the segment 2170 is coupled with a coupling portion 2183 of the segment 2180. A coupling portion 2184 of the segment 2180 is coupled with the segment 2190.

Further, the segment 2200 is coupled next to the segment 2190, and the segment 2210 is coupled next to the segment 2200. In each of the coupling portions, two segments are coupled using a connecting pin (not illustrated).

On the front surface of the segment 2170, the slit 2173 is formed. The plurality of light-emitting diodes constituting the display 4108 are arranged in the inner chassis 2500 formed close to the slit 2173 and made of a transparent or translucent resin. Accordingly, the user can check the light emission or blinking of the light-emitting diodes through the slit 2173 of the segment 2170. By the light emission or blinking of such the light-emitting diodes, various states such as an incoming call and e-mail reception are notified. Inside the inner chassis 2500 close to the slit 2173, the antennas 4103, 4105, and 4107 are arranged. Accordingly, each of the antennas 4103, 4105, and 4107 is capable of maintaining a good communication state with the outside of the metal segment 2170.

A first portion 2401 of the flexible circuit board 2400 is arranged in the inner chassis 2500 of the segment 2170. The first portion 2401 of the flexible circuit board 2400 is connected to a rigid board 2440 via a connection member 2431. Various electronic components 2441, 2442, 2443, . . . are connected to the rigid board 2440. The electronic components 2441, 2442, 2443, . . . correspond to the processing units 4101 to 4113 shown in FIG. 17.

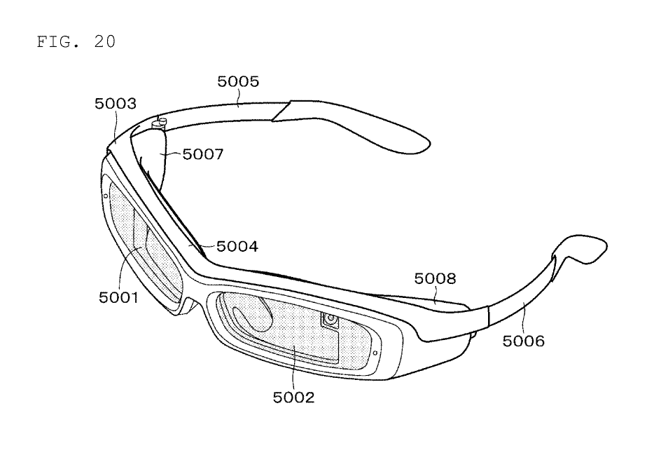

The segment 2190 and the segment 2210 have a size enough to house the batteries 2411 and 2421. The segment 2180 and the segment 2200 are smaller in size than the segments 2190 and 2210. A second portion 2402 of the flexible circuit board 2400 is meanderingly arranged in the segment 2180. The battery 2411 is connected to a third portion 2403 of the flexible circuit board 2400. A fourth portion 2404 of the flexible circuit board 2400 is meanderingly arranged in the segment 2200. The battery 2421 is connected to a fifth portion 2405 of the flexible circuit board 2400. Details of the meandering state of the flexible circuit board 2400 will be described with reference to FIG. 18.

(Arrangement State of Flexible Circuit Board)

FIG. 18 shows a cross section of a state in which the flexible circuit board 2400 is arranged inside the segments 2170 to 2190. The flexible circuit board 2400 is arranged continuously inside of the segments 2170 to 2190. As shown in FIG. 18, the flexible circuit board 2400 passes through inside of the coupling portion 2171 of the segment 2170 and the coupling portion 2183 of the segment 2180. In this case, in the coupling portion 2171, a waterproof member 2174 is arranged in a position where the flexible circuit board 2400 passes through, thereby blocking water from entering the inside of the segment 2170. In addition, a waterproof member 2175 is arranged in the inner chassis 2500 of the segment 2170.

Waterproof members 2181 and 2182 (refer to FIG. 15) are arranged inside the segment 2180, thereby blocking water from entering the inside of the segment 2180. Each of the waterproof members 2174, 2175, 2181, and 2182 is molded, for example, of a relatively soft resin, and a gap between the inside of the segment 2180 and the flexible circuit board 2400 is filled. Then, the flexible circuit board 2400 is meanderingly arranged inside the segment 2180. That is, a curved meandering portion 2400X is formed on the flexible circuit board 2400 inside the segment 2180.

The meandering portion 2400X of the flexible circuit board 2400 functions so as to prevent the flexible circuit board 2400 from being damaged. For example, even when the coupling portion between the segment 2180 and the segment 2170 is largely bent, the meandering portion 2400X of the flexible circuit board 2400 linearly extends, so that the flexible circuit board 2400 is not pulled. Accordingly, a problem such as breakage of the circuit pattern in the flexible circuit board 2400 will not occur.

The meandering portion 2400X shown in FIG. 18 is an example, and other shapes may be adopted. That is, the meandering portion 2400X may have various meandering shapes such as an S shape, a V shape, a U shape, a Z shape, a curved shape, a semicircular shape, and a polygonal line shape.

The present invention can be applied in a case where an all-solid-state battery is used as the battery 2411 described above.

(Battery Arrangement State)

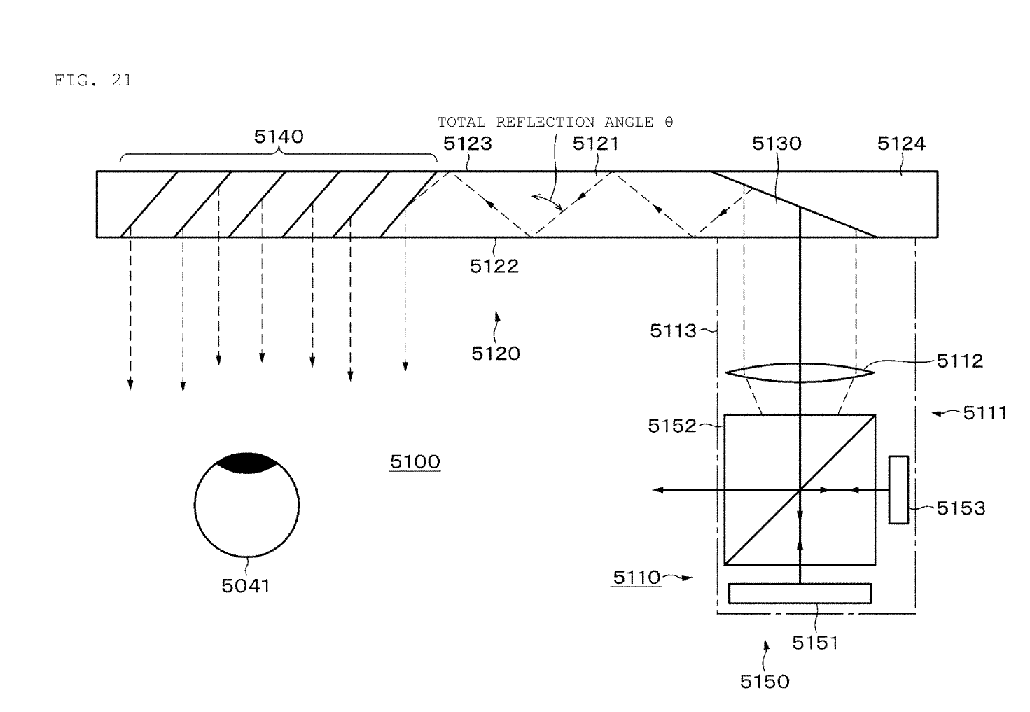

FIG. 19 shows a state in which the battery 2411 is arranged in the segment 2190. The configuration in which the battery 2421 is arranged in the segment 2210 is also the same. The battery 2411 is arranged in a battery arrangement portion 2191 inside the segment 2190. At this time, an adhesive sheet 2703 is arranged between the battery arrangement portion 2191 and the battery 2411.

Further, the third portion 2403 of the flexible circuit board 2400 is adhered to the front surface (the upper side in FIG. 19) of the battery 2411 via an adhesive sheet 2701. Via the adhesion using the adhesive sheet 2701, electrodes 2411A and 2411B on the surface of the battery 2411 are connected with the circuit pattern in the flexible circuit board 2400. Further, the surface of the battery 2411 is adhered with a lid (not illustrated) of the segment 2190 via an adhesive sheet 2702. Here, the adhesive sheet 2701 is configured to block the periphery of the surface of the battery 2411. Accordingly, the adhesive sheet 2701 functions as a waterproof member of the battery 2411 in the segment 2190. Note that the battery may be arranged in another segment of the band type electronic device 2000.

The above-mentioned smartwatch is capable of performing notification such as e-mails and incoming calls, record of logs of user's action history, call, and the like. The smartwatch includes a function as a contactless IC card, and is capable of performing settlement and authentication using the contactless IC card. Moreover, a watch same as a conventional watch can be used for the watch main body of the smartwatch of this example, thereby providing a watch excellent in design. In addition, the plurality of segments have a waterproof structure and are arranged meanderingly on the flexible circuit board, thereby having an effect of not cutting the circuit pattern. Further, the antenna in the metal segment 2170 is arranged in the vicinity of the slit of the segment 2170, thereby realizing good transmission and reception.

“Eyeglass Type Terminal as Application Example”

Hereinafter, application examples will be described in which the present invention is applied to eyeglass type terminals represented by a type of head-mounted displays (HMD).

The eyeglass type terminal described below is capable of displaying information such as text, symbols, and images superimposed on the landscape in front of the user. That is, a lightweight and thin image display device display module dedicated to the transmissive eyeglass type terminal is mounted.

This image display device includes an optical engine and a hologram light guide plate. The optical engine emits image light such as images and texts using a micro display lens. This image light enters the hologram light guide plate. The hologram light guide plate has a hologram optical element incorporated at both end portions of a transparent plate, thereby transmitting image light from the optical engine to the observer's eyes by propagating it through a very thin transparent plate of such as 1 mm in thickness. Such configuration realizes a lens having a thickness of 3 mm (including a protective plate around the light guide plate) with a transmittance of 85%, for example. Such eyeglass type terminal allows real-time viewing of results of the players and teams during watching of a sport game, and allows display of a travel guide at a travel destination.

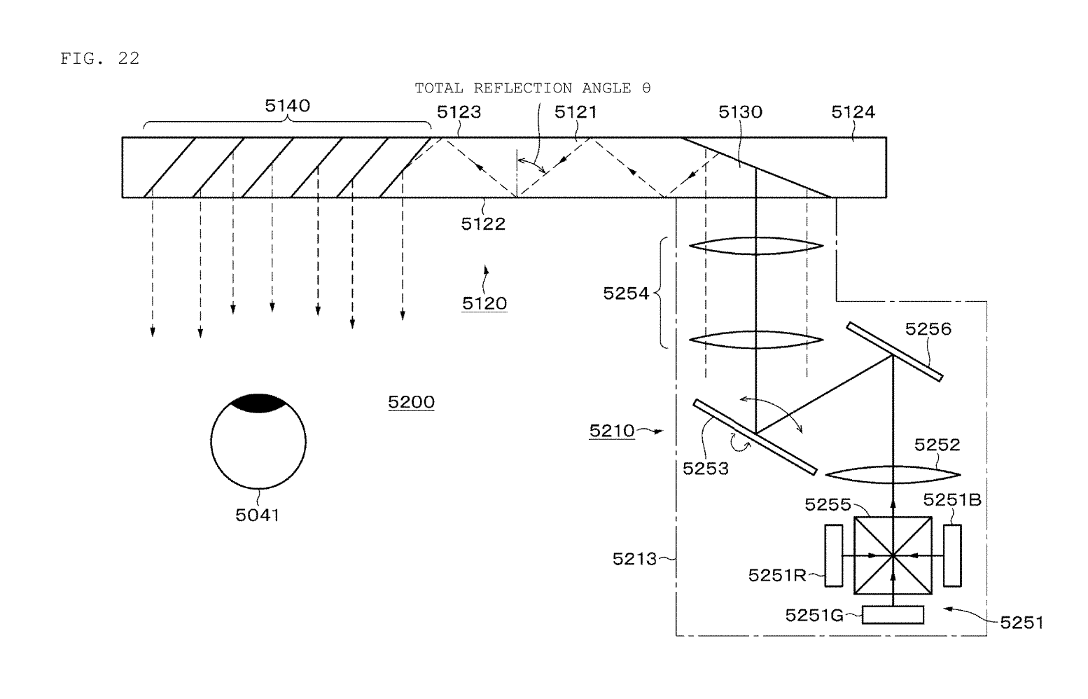

A specific example of the eyeglass type terminal includes an image display unit having an eyeglass type configuration as shown in FIG. 20. That is, similar to the normal eyeglass, it has a frame 5003 for retaining a right image display unit 5001 and a left image display unit 5002 in front of the eyes. The frame 5003 is composed of a front portion 5004 arranged on the front of the observer and two temple units 5005 and 5006 pivotally attached to the both ends of the front portion 5004 via hinges. The frame 5003 is made of the same material as the material constituting ordinary glasses, such as metal, alloy, plastic, and a combination thereof. Note that a headphone portion may be provided.

The right image display unit 5001 and the left image display unit 5002 are arranged so as to be positioned in front of the user's right eye and in front of the user's left eye, respectively. The temple units 5005 and 5006 retain the right image display unit 5001 and the left image display unit 5002, respectively, on the user's head. A right display driving unit 5007 is arranged inside the temple unit 5005 at a connection portion between the front portion 5004 and the temple unit 5005. A left display driving unit 5008 is arranged inside the temple unit 5006 at a connection portion between the front portion 5004 and the temple unit 5006.

Although not illustrated in FIG. 20, a battery, an acceleration sensor, a gyroscope, an electronic compass, a microphone/speaker, and the like are mounted on the frame 5003. The present invention can be applied when an all-solid-state battery is used. Further, an imaging device is attached, thereby allowing shooting of still images/moving images. Furthermore, a controller connected with the eyeglass portion via, for example, a wireless or wired interface is included. The controller is provided with a touch sensor, various buttons, a speaker, a microphone, and the like. Furthermore, it has a linkage function with smartphones. For example, it is possible to utilize the GPS function of a smartphone to provide information in response to the user's situation. Hereinafter, the image display device (the right image display unit 5001 or the left image display unit 5002) will mainly be described.

FIG. 21 shows a conceptual diagram of the first example of the image display device (the right image display unit 5001 or the left image display unit 5002) of the eyeglass type terminal. The image display device in the eyeglass type terminal of the first example includes a first configuration of an image generation device and a first configuration of an optical device.

An image display device 5100 includes an image generation device 5110 including an image generation device of the first configuration and an optical device (light guide means) 5120 where light emitted from the image generation device 5110 enters, is guided, and is emitted towards a pupil 5041 of the observer. The optical device 5120 is attached to the image generation device 5110.

The optical device 5120 is composed of the optical device of the first configuration, and includes: a light guide plate 5121 in which light entering from the image generation device 5110 propagates through the inside by total reflection and is then emitted towards the pupil 5041 of the observer; a first deflection means 5130 for deflecting light entering the light guide plate 5121 so that the light entering the light guide plate 5121 is totally reflected inside the light guide plate 5121; and a second deflection means 5140 for deflecting for a plurality of times the light propagated through the inside of the light guide plate 5121 by total reflection in order to emit from the light guide plate 5121 the light propagated through the inside of the light guide plate 5121 by total reflection.

The first deflection means 5130 and the second deflection means 5140 are placed inside the light guide plate 5121. The first deflection means 5130 reflects the light entering the light guide plate 5121, and the second deflection means 5140 transmits and reflects for a plurality of times the light propagated through the inside of the light guide plate 5121 by total reflection. That is, the first deflection means 5130 functions as a reflecting mirror and the second deflection means 5140 functions as a semi-transmissive mirror. More specifically, the first deflection means 5130 provided inside the light guide plate 5121 is made of aluminum and is composed of a light reflecting film (a kind of mirror) that reflects light entering the light guide plate 5121. On the other hand, the second deflection means 5140 provided inside the light guide plate 5121 is composed of a multilayered laminate structure in which a multitude of dielectric laminated films are laminated. The dielectric laminated film is composed of, for example, a TiO₂ film as a high dielectric constant material and a SiO₂ film as a low dielectric constant material. Although six layers of dielectric laminated films are illustrated in the figure, the present invention is not limited thereto.

A thin piece made of the same material as the material constituting the light guide plate 5121 is sandwiched between the dielectric laminated film and the dielectric laminated film. In the first deflection means 5130, parallel light entering the light guide plate 5121 is reflected (or diffracted) such that the parallel light entering the light guide plate 5121 is totally reflected inside the light guide plate 5121. On the other hand, in the second deflection means 5140, parallel light propagated through the inside of the light guide plate 5121 by total reflection is reflected (or diffracted) for a plurality of times, and is emitted from the light guide plate 5121 in a state of parallel light.

As for the first deflection means 5130, by cutting out a portion 5124 of the light guide plate 5121 where the first deflection means 5130 is provided, a slope on which the first deflection means 5130 is to be formed is provided on the light guide plate 5121. After vacuum deposition of a light reflection film onto the slope, the cut out portion 5124 of the light guide plate 5121 may be adhered to the first deflection means 5130. As for the second deflection means 5140, a multilayered laminate structure is prepared in which a multitude of the same material (for example, glass) as the material constituting the light guide plate 5121 and dielectric laminated films (that can be formed by vacuum deposition, for example) are laminated, a portion 5125 of the light guide plate 5121 where the second deflection means 5140 is provided is cut out to form a slope, and the multilayered laminate structure may be adhered to the slope and polished to adjust the outer shape. Thus, it is possible to obtain the optical device 5120 in which the first deflection means 5130 and the second deflection means 5140 are provided inside the light guide plate 5121.

The light guide plate 5121 made of optical glass and plastic material has two parallel surfaces (a first surface 5122 and a second surface 5123) extending in parallel with an axis of the light guide plate 5121. The first surface 5122 and the second surface 5123 are opposed to each other. Then, parallel light enters from the first surface 5122 corresponding to a light entering surface, propagates through the inside by total reflection, and then is emitted from the first surface 5122 corresponding to a light emitting surface.

The image generation device 5110 includes an image formation device 5111 including the image generation device of the first configuration and having a plurality of pixels aligned in a two-dimensional matrix, and a collimator optical system 5112 that collimates and emits light having been emitted from each of the pixels of the image formation device 5111.

Here, the image formation device 5111 includes a reflective spatial light modulation device 5150 and a light source 5153 constituted by a light-emitting diode that emits white light. More specifically, the reflective spatial light modulation device 5150 includes a liquid crystal display device (LCD) 5151 made of LCOS (Liquid Crystal On Silicon) as a light valve, and a polarization beam splitter 5152 that reflects a part of light from the light source 5153 and guides it to the liquid crystal display device 5151 and passes through a part of light reflected by the liquid crystal display device 5151 and guides it to the collimator optical system 5112. Note that the LCD is not limited to those of the LCOS type.

The liquid crystal display device 5151 includes a plurality of (320×240, for example) pixels aligned in a two-dimensional matrix. The polarization beam splitter 5152 has a well-known configuration and structure. Non-polarized light emitted from the light source 5153 collides with the polarization beam splitter 5152. In the polarization beam splitter 5152, the P polarization component passes through and is emitted outside the system. On the other hand, the S polarization component is reflected by the polarization beam splitter 5152, enters the liquid crystal display device 5151, is reflected inside the liquid crystal display device 5151, and is emitted from the liquid crystal display device 5151. Among the beams of light emitted from the liquid crystal display device 5151, a beam of light emitted from a pixel displaying “white” includes a multitude of P polarization components, and a beam of light emitted from a pixel displaying “black” includes a multitude of S polarization components. Accordingly, among the beams of light emitted from the liquid crystal display device 5151 and colliding with the polarization beam splitter 5152, the P polarization component passes through the polarization beam splitter 5152 and is guided to the collimator optical system 5112.

On the other hand, the S polarization component is reflected by the polarization beam splitter 5152 and returned to the light source 5153. The liquid crystal display device 5151 includes a plurality of (320×240, for example) pixels (the number of liquid crystal cells is three times the number of pixels) aligned in a two-dimensional matrix, for example. The collimator optical system 112 includes, for example, a convex lens, and in order to generate parallel light, the image formation device 5111 (more specifically, the liquid crystal display device 5151) is arranged in the portion (position) of the focal length in the collimator optical system 5112. In addition, one pixel is constituted by a red light-emitting sub-pixel that emits red light, a green light-emitting sub-pixel that emits green light, and a blue light-emitting sub-pixel that emits blue light.

Furthermore, in the eyeglass type terminal including the preferable configuration and structure described above, the image display device includes the image generation device and the optical device (light guide means) where light emitted from the image generation device enters, is guided, and is emitted towards the pupil of the observer. The optical device can be configured to be attached to, for example, the image generation device.

The second example is a variation of the first example. FIG. 22 shows a conceptual diagram of an image display device 5200 in the eyeglass type terminal of the second example. In the second example, an image generation device 5210 includes an image generation device of the second configuration. Specifically, it includes a light source 5251, a collimator optical system 5252 that collimates light emitted from the light source 5251, a scanning means 5253 that scans the parallel light emitted from the collimator optical system 5252, and a relay optical system 5254 that relays and emits the parallel light scanned by the scanning means 5253. The image generation device 5210 is covered with a cover 5213.

The light source 5251 is constituted by a red light-emitting element 5251R that emits red light, a green light-emitting element 5251G that emits green light, and a blue light-emitting element 5251B that emits blue light, and each of the light-emitting elements is composed of a semiconductor laser element. Light of the three primary colors emitted from the light source 5251 passes through a cross prism 5255 to perform color synthesis, the optical path is unified, enters the collimator optical system 5252 having a positive optical power as a whole, and is emitted as collimated light. The parallel light is reflected by a total reflection mirror 5256, makes a micromirror rotatable in a two-dimensional direction, undergoes horizontal scanning and vertical scanning by the scanning means 5253 composed of a micro electro mechanical system (MEMS) capable of two-dimensionally scanning the entering parallel light, and is made a kind of two-dimensional image, thereby generating a virtual pixel. Then, light from the virtual pixel passes through the relay optical system 5254 composed of a well-known relay optical system, and a collimated light flux enters the optical device 5120.

Since the optical device 5120 where a light beam collimated by the relay optical system 5254 enters, is guided, and is emitted has the same configuration and structure as those of the optical device described in the first example, a detailed description is omitted. Also, since the eyeglass type terminal of the second example has substantially the same configuration and structure as those of the eyeglass type terminal of the first example except that the image generation device 5210 is different, as described above, a detailed description is omitted.

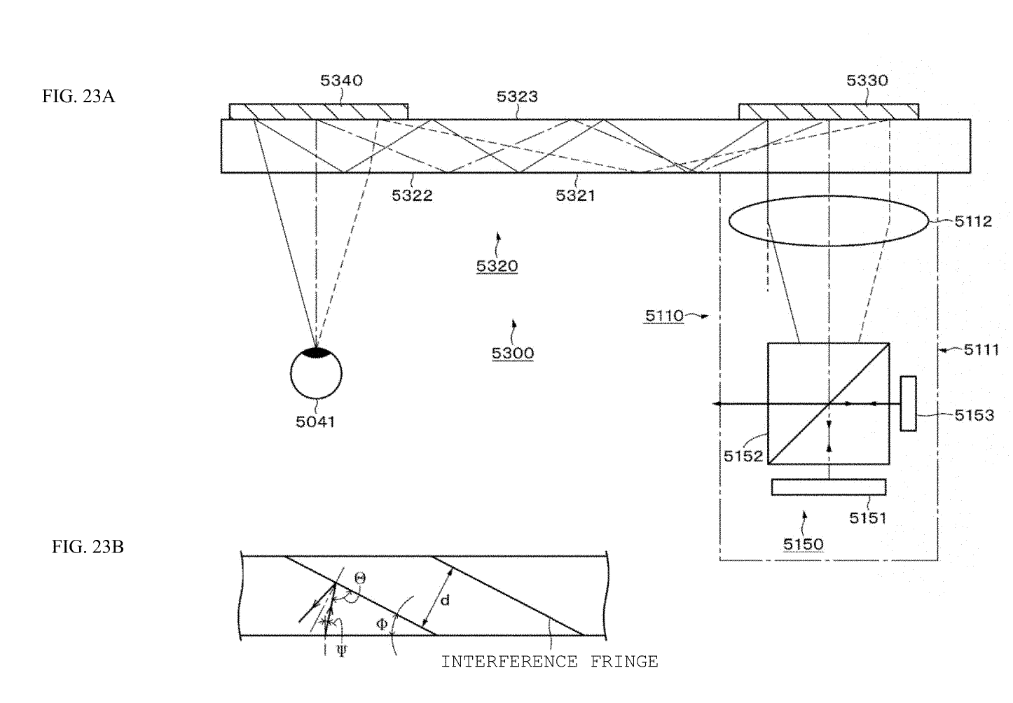

The third example is also a variation of the first example. FIG. 23A shows a conceptual diagram of an image display device 5300 in the eyeglass type terminal of the third example. FIG. 23B shows a schematic cross-sectional view showing a part of a reflection type volume hologram diffraction grating in an enlarged manner. In the third example, the image generation device 5110 has the same configuration as that of the first example. Further, an optical device (light guide means) 5320 has the same basic configuration as that of the optical device 5120 of the first example except that the configuration and structure of the first deflection means and the second deflection means are different.

That is, similarly to the optical device 5120 of the first example, it includes: a light guide plate 5321 in which light entering from the image generation device 5110 propagates through the inside by total reflection and is then emitted towards the pupil 5041 of the observer; a first deflection means 5330 for deflecting light entering the light guide plate 5321 so that the light entering the light guide plate 5321 is totally reflected inside the light guide plate 5321; and a second deflection means 5340 for deflecting for a plurality of times the light propagated through the inside of the light guide plate 5321 by total reflection in order to emit from the light guide plate 5321 the light propagated through the inside of the light guide plate 5321 by total reflection.

In the third example, the optical device 5320 is composed of the optical device of the second configuration. That is, the first deflection means and the second deflection means are placed on the surface of the light guide plate 5321 (specifically, a second surface 5323 of the light guide plate 5321). The first deflection means diffracts light entering the light guide plate 5321, and the second deflection means diffracts for a plurality of times light propagated through the inside of the light guide plate 5321 by total reflection. Here, the first deflection means and the second deflection means are composed of a diffraction grating element, specifically a reflection type diffraction grating element, and more specifically a reflection type volume hologram diffraction grating. In the following description, the first deflection means composed of the reflection type volume hologram diffraction grating will be referred to as a “first diffraction grating member 5330” for the sake of convenience and the second deflection means composed of the reflection type volume hologram diffraction grating will be referred to as a “second diffraction grating member 5340” for the sake of convenience.

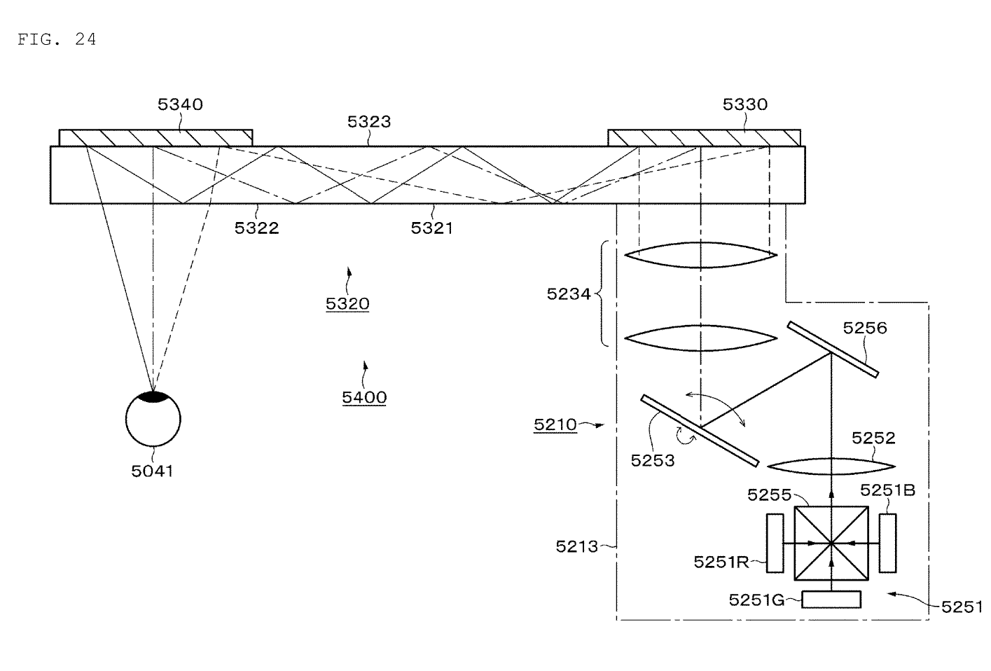

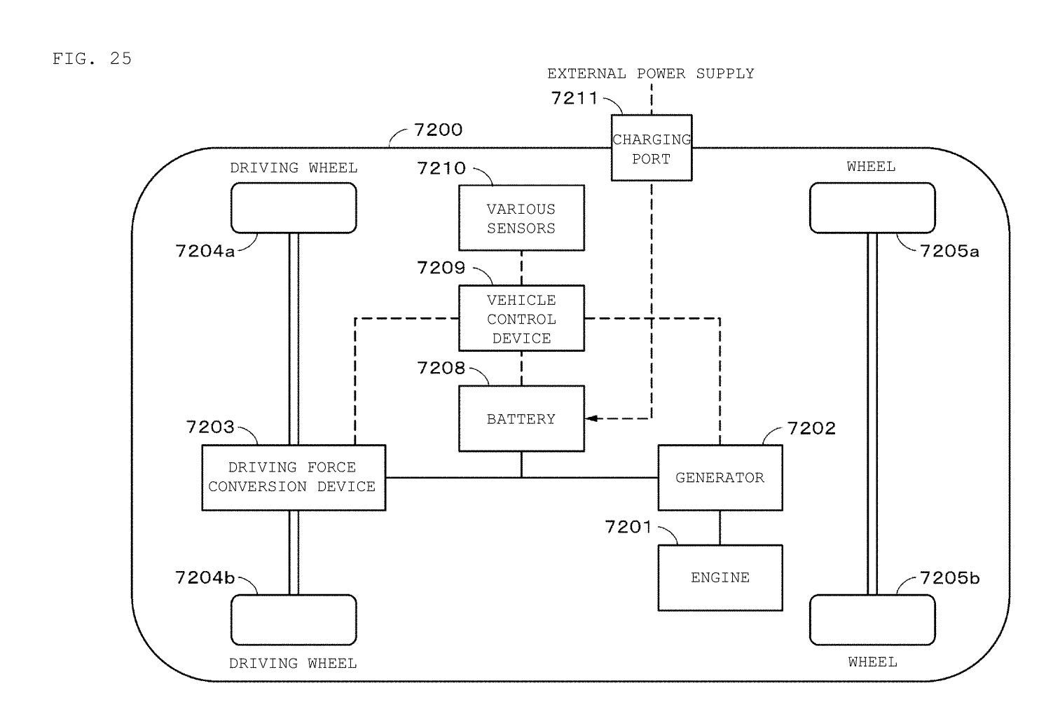

In the third example or the fourth example to be described later, the first diffraction grating member 5330 and the second diffraction grating member 5340 have a configuration in which diffraction grating layers of P layer composed of a reflection type volume hologram diffraction grating are laminated in order to correspond to diffraction reflection of P kinds of light having wavelength bands (or wavelengths) of different P types (specifically, P=3, and the three kinds of red, green, and blue). An interference fringe corresponding to one type of wavelength band (or wavelength) is formed in each of the diffraction grating layers composed of a photopolymer material, and is prepared by a conventional method. More specifically, the first diffraction grating member 5330 and the second diffraction grating member 5340 have a configuration in which a diffraction grating layer that diffracts and reflects red light, a diffraction grating layer that diffracts and reflects green light, and a diffraction grating layer that diffracts and reflects blue light are laminated. The pitch of the interference fringe formed on the diffraction grating layer (diffraction optical element) is constant, and the interference fringe is linear and parallel to the Z axis direction. The axial direction of the first diffraction grating member 5330 and the second diffraction grating member 5340 is defined as the Y axis direction, and the normal direction is defined as the X axis direction. In FIG. 23A and FIG. 24, the first diffraction grating member 5330 and the second diffraction grating member 5340 are shown as one layer. By adopting such a structure, it is possible to increase the diffraction efficiency, increase the diffraction acceptance angle, and optimize the diffraction angle at the time light having each of the wavelength bands (or wavelength) is diffracted and reflected by the first diffraction grating member 5330 and the second diffraction grating member 5340.

FIG. 23B shows an enlarged schematic partial cross-sectional view of the reflection type volume hologram diffraction grating. In the reflection type volume hologram diffraction grating, an interference fringe having an inclination angle cp is formed. Here, the inclination angle cp refers to the angle formed by the surface of the reflection type volume hologram diffraction grating and the interference fringe. The interference fringe is formed from the inside to the surface of the reflection type volume hologram diffraction grating. The interference fringe satisfies the Bragg condition. Here, the Bragg condition refers to a condition that satisfies the following expression (A).

In the expression (A), m is a positive integer, A is a wavelength, d is the pitch of the grating plane (the interval in the normal direction of the virtual plane including the interference fringe), and 8 is the complementary angle of the angle entering the interference fringe. In addition, the relationship among Θ, the inclination angle φ, and the incident angle ψ when light enters the diffraction grating member at an incident angle ψ is as shown in expression (B).

M·λ=2·d·sin(Θ) (A)

Θ=90°−(φ+ψ) (B)

As described above, the first diffraction grating member 5330 is placed (adhered) on the second surface 5323 of the light guide plate 5321, and diffracts and reflects this parallel light entering the light guide plate 5321 so that this parallel light entering the light guide plate 5321 from a first surface 5322 is totally reflected inside the light guide plate 5321. Furthermore, as described above, the second diffraction grating member 5340 is placed (adhered) on the second surface 5323 of the light guide plate 5321, and diffracts and reflects for a plurality of times this parallel light propagated through the inside of the light guide plate 5321 by total reflection and emits it from the first surface 5322 as parallel light from the light guide plate 5321.

Even in the light guide plate 5321, parallel lights of the three colors of red, green, and blue propagate through the inside by total reflection, and are then emitted. At this time, since the light guide plate 5321 is thin and the optical path proceeding the inside of the light guide plate 5321 is long, the number of total reflections up to the second diffraction grating member 5340 is different depending on each angle of view. More specifically, among the parallel light entering the light guide plate 5321, the number of reflections of the parallel light entering at an angle in a direction getting close to the second diffraction grating member 5340 is smaller than the number of reflections of the parallel light entering the light guide plate 5321 at an angle in a direction getting away from the second diffraction grating member 5340. This is because the angle formed by the light propagating through the inside of the light guide plate 5321 and the normal line of the light guide plate 5321 when colliding with the inner surface of the light guide plate 5321 is smaller in the parallel light entering the light guide plate 5321 at an angle in the direction getting close to the second diffraction grating member 5340 than in the parallel light entering the light guide plate 5321 at an angle in the direction opposite thereto, among the parallel light diffracted and reflected by the first diffraction grating member 5330. The shape of the interference fringe formed inside the second diffraction grating member 5340 and the shape of the interference fringe formed inside the first diffraction grating member 5330 are in a relationship symmetrical with respect to a virtual plane perpendicular to the axis of the light guide plate 5321.

Basically, the light guide plate 5321 in the fourth example described later also has the same configuration and structure as those of the light guide plate 5321 described above.

Since the eyeglass type terminal of the third example has substantially the same configuration and structure as those of the eyeglass type terminal of the first example except that the optical device 5320 is different, as described above, a detailed description is omitted.

The fourth example is a variation of the third example. FIG. 24 shows a conceptual diagram of an image display device in the eyeglass type terminal of the fourth example. The light source 5251, the collimator optical system 5252, the scanning means 5253, the relay optical system 5254, and the like in an image display device 5400 of the fourth example has the same configuration and structure as those of the second example. The optical device 5320 in the fourth example has the same configuration and structure as those of the optical device 5320 in the third example. Since the eyeglass type terminal of the fourth example has substantially the same configuration and structure as those of the eyeglass type terminal of the first example except for the differences above, a detailed description is omitted.

“Power Storage System in Vehicle as Application Example”

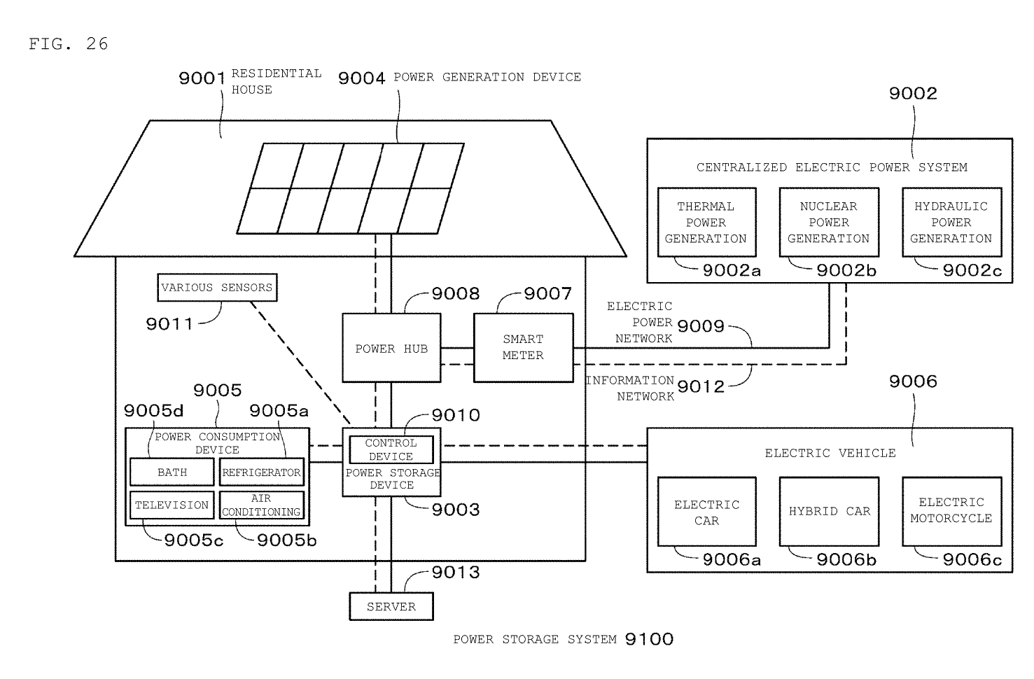

An example in which the present disclosure is applied to a power storage system for vehicle will be described with reference to FIG. 25. FIG. 25 schematically shows an example of the configuration of a hybrid vehicle adopting a series hybrid system to which the present disclosure is applied. The series hybrid system is a vehicle that runs on an electric power driving force conversion device using electric power generated by a generator driven by an engine or electric power thereof temporarily stored in a battery.

A hybrid vehicle 7200 includes an engine 7201, a generator 7202, an electric power driving force conversion device 7203, a driving wheel 7204a, a driving wheel 7204b, a wheel 7205a, a wheel 7205b, a battery 7208, a vehicle control device 7209, various sensors 7210, and a charging port 7211. The above-described power storage device of the present disclosure is applied to the battery 7208.

The hybrid vehicle 7200 runs with the electric power driving force conversion device 7203 as a power supply. An example of the electric power driving force conversion device 7203 is a motor. The electric power driving force conversion device 7203 operates on the electric power of the battery 7208, and the rotational force of the electric power driving force conversion device 7203 is transmitted to the driving wheels 7204a and 7204b. It should be noted that by using direct-current-alternating-current (DC-AC) or a reverse conversion (AC-DC conversion) where necessary, the electric power driving force conversion device 7203 can be applied to both an AC motor and a DC motor. The various sensors 7210 control the engine speed via the vehicle control device 7209 and control the opening degree (throttle opening degree) of a throttle valve that is not illustrated. The various sensors 7210 include a speed sensor, an acceleration sensor, and an engine speed sensor.

The rotational force of the engine 7201 is transmitted to the generator 7202, and the power generated by the generator 7202 with the rotational force can be stored in the battery 7208.

When the hybrid vehicle decelerates by a braking mechanism not illustrated, the decelerating resistance force is applied as a rotational force to the electric power driving force conversion device 7203, and the regenerative electric power generated by the electric power driving force conversion device 7203 with the rotational force is stored in the battery 7208.

By being connected to an external power supply of the hybrid vehicle, the battery 7208 is capable of receiving power supply from the external power supply with the charging port 211 as an input port and also storing the received power.

Although not illustrated, it may include an information processing device that performs information processing related to vehicle control on a basis of information on the secondary battery. Examples of such information processing device include an information processing device that displays the remaining battery level on a basis of information on the remaining amount of the battery, for example.

The above explanation has used an example of a series hybrid vehicle that runs with a motor using electric power generated by the generator driven by the engine or the electric power thereof temporarily stored in the battery. However, the present disclosure is also effectively applicable to a parallel hybrid vehicle in which the both outputs of the engine and the motor are driving sources and the three modes of traveling only with the engine, traveling only with the motor, and traveling with the engine and the motor are appropriately switched at the time of use. Furthermore, the present disclosure is also effectively applicable to a so-called electric vehicle that runs on drive only by a driving motor without using an engine.

An example of the hybrid vehicle 7200 to which the invention according to the present disclosure can be applied has been described above. The invention according to the present disclosure can be preferably applied to the battery 7208 among the above-described configuration. Specifically, deterioration of the battery can be prevented by using an all-solid-state battery as the battery 7208 and applying the invention according to the present invention as the charging and discharging device.

“Power Storage System in Residential House as Application Example”

An example in which the present disclosure is applied to a power storage system for residential house will be described with reference to FIG. 26. For example, in a power storage system 9100 for a residential house 9001, electric power is supplied to a power storage device 9003 from a centralized electric power system 9002 such as a thermal power generation 9002a, a nuclear power generation 9002b, and a hydraulic power generation 9002c via an electric power network 9009, an information network 9012, a smart meter 9007, a power hub 9008, and the like. Together with this, power is supplied from an independent power supply such as a domestic power generation device 9004 to the power storage device 9003. The power supplied to the power storage device 9003 is stored. The power to be used in the residential house 9001 is supplied using the power storage device 9003. A similar power storage system can be used for buildings as well as for the residential house 9001.

The residential house 9001 is provided with the power generation device 9004, a power consumption device 9005, the power storage device 9003, a control device 9010 that controls each device, the smart meter 9007, and a sensor 9011 that acquires various types of information. Each of the devices is connected via the electric power network 9009 and the information network 9012. A solar cell, a fuel cell, or the like is used as the power generation device 9004, and the generated power is supplied to the power consumption device 9005 and/or the power storage device 9003. The power consumption device 9005 is a refrigerator 9005a, an air conditioning device 9005b, a television receiver 9005c, a bath 9005d, and the like. Furthermore, the power consumption device 9005 includes an electric vehicle 9006. The electric vehicle 9006 is an electric car 9006a, a hybrid car 9006b, and an electric motorcycle 9006c.

The all-solid-state battery of the present disclosure described above is applied to the power storage device 9003.

The power storage device 9003 is constituted by a secondary battery or a capacitor. For example, it is constituted by a lithium-ion battery. The lithium ion battery may be of stationary type or may be the one used in the electric vehicle 9006. The smart meter 9007 includes a function of measuring the usage amount of commercial power and sending the measured usage amount to the electric power company. The electric power network 9009 may use any one or a combination of DC power feed, AC power feed, and contactless power feed.

The various sensors 9011 are, for example, a human motion sensor, an illuminance sensor, an object detection sensor, a power consumption sensor, a vibration sensor, a contact sensor, a temperature sensor, an infrared sensor, and the like. The information acquired by the various sensors 9011 is transmitted to the control device 9010. In response to the information from the sensor 9011, the state of the weather, the state of a person, and the like are grasped and the power consumption device 9005 is automatically controlled to minimize the energy consumption. Further, the control device 9010 is capable of transmitting information on the residential house 9001 to an external electric power company or the like via the Internet.

The power hub 9008 performs processing such as branching of the power line and DC/AC conversion. Communication methods of the information network 9012 connected with the control device 9010 include a method using a communication interface such as UART (Universal synchronous Receiver-Transmitter: transmission/reception circuit for asynchronous serial communication) a method of using a sensor network according to a wireless communication standard such as Bluetooth (registered trademark), ZigBee, and Wi-Fi. The Bluetooth (registered trademark) method is applied to multimedia communication and is capable of performing communication of point-to-multipoint connection. ZigBee uses the physical layer of IEEE (Institute of Electrical and Electronics Engineers) 802.15.4. IEEE 802.15.4 is the name of a short-distance wireless network standard called Personal Area Network (PAN) or Wireless Personal Area Network (WPAN).

The control device 9010 is connected with an external server 9013. The server 9013 may be managed by any of the residential house 9001, an electric power company, or a service provider. The information transmitted and received by the server 9013 is, for example, power consumption information, daily life pattern information, electric power fee, weather information, natural disaster information, and power trade information. These pieces of information may be transmitted from and received to a power consumption device (for example, a television receiver) inside the home, while they may be transmitted from and received to a device (for example, a mobile phone and the like) outside the home. These pieces of information may be displayed on a device having a display function, for example, a television receiver, a mobile phone, personal digital assistants (PDA), or the like.

The control device 9010 that controls each unit is configured with a central processing unit (CPU), a random access memory (RAM), a read only memory (ROM), and the like, and is stored in the power storage device 9003 in this example. The control device 9010 is connected to the power storage device 9003, the domestic power generation device 9004, the power consumption device 9005, the various sensors 9011, and the server 9013 via the information network 9012, and has, for example, a function of adjusting the usage amount of the commercial power and the power generation amount. It may include a function of conducting electric power trading in the electric power market, and other functions.

As described above, it is possible to store in the power storage device 9003 the power generated by the domestic power generation device 9004 (solar power generation, wind power generation) in addition to the power from the centralized electric power system 9002 such as the thermal power 9002a, the nuclear power 9002b, and the hydraulic power 9002c.

Accordingly, even if the generated power of the domestic power generation device 9004 fluctuates, it is possible to perform control such that the amount of electric power sent to the outside is made constant or discharged as necessary. For example, it is possible to store the power obtained by photovoltaic power generation in the power storage device 9003, store at night the midnight power, of which the electricity rate is low, in the power storage device 9003, and discharge and use in daytime, in which electricity rate is high, the power stored by the power storage device 9003.

While an example in which the control device 9010 is stored in the power storage device 9003 has been described in this example, it may be stored in the smart meter 9007 or may be configured alone. Furthermore, the power storage system 9100 may be used for a plurality of homes in a collective housing, or may be used for a plurality of single-family houses.

An example of the power storage system 9100 to which the invention according to the present disclosure can be applied has been described above. The invention according to the present disclosure can be preferably applied to the power storage device 9003 in the above-described configuration. However, since the present invention is to supply DC power, it is necessary to convert DC power into AC power when supplying it to AC home appliances.

While the embodiments, the variations, and the examples of the present invention have been described above in a specific manner, the present invention is not limited to the above-described embodiments, the variations, and the examples, and various modifications based on the technical idea of the present invention are possible.

For example, the configurations, methods, processes, shapes, materials, numerical values, and the like described in the above-described embodiments, the variations, and the examples are merely examples, and configurations, methods, processes, shapes, materials, numerical values, and the like different from them may be used as necessary. In addition, the chemical formulae of compounds and the like are representative, and are not limited to the listed valences and the like as long as they are common names of the same compounds.

In addition, the configurations, methods, processes, shapes, materials, numerical values, and the like in the above-described embodiments, the variations, and the examples can be combined with each other without departing from the scope of the present invention.

### DESCRIPTION OF REFERENCE SYMBOLS

11, 21: solid electrolyte layer

12, 22A: positive electrode layer

13, 23A: negative electrode layer

14, 22B: positive electrode collector layer

15, 23B: negative electrode collector layer

20, 20A: laminate

22: positive electrode

23: negative electrode

24A, 24B, 24C, 25A, 25B, 25C: insulation layer

26A: positive electrode terminal

26B: negative electrode terminal

20Sa: first side surface

20Sb: second side surface

1. An all-solid-state battery, comprising a positive electrode;
a negative electrode; and
an electrolyte layer between the positive electrode and the negative electrode,
wherein
at least one of the positive electrode, the negative electrode, and the electrolyte layer includes a lithium ion conductor having an exothermic peak in a differential thermal analysis, and
a first ionic conductivity on a first side of a temperature higher than a rising temperature of the exothermic peak is lower than a second ionic conductivity on a second side of a temperature lower than the rising temperature of the exothermic peak.

2. The all-solid-state battery according to claim 1, wherein the rising temperature of the exothermic peak is in a range of 300° C. to 550° C.

3. The all-solid-state battery according to claim 1, wherein a reduction rate of ionic conductivity expressed by [(σ(low T)−σ(high T))/σ(low T)]×100 is 85% or more,
where σ(low T)[S/cm] is the second ionic conductivity at Ta [° C.]−-25 [° C.], σ(high T)[S/cm] is the first ionic conductivity at Ta [° C.]+25 [° C.], and Ta is the rising temperature [° C.] of the exothermic peak.

4. The all-solid-state battery according to claim 3, wherein the reduction rate of the ionic conductivity is 90% or more.

5. The all-solid-state battery according to claim 1, wherein the exothermic peak is an exothermic peak due to recrystallization of the lithium ion conductor.

6. The all-solid-state battery according to claim 1, wherein the lithium ion conductor contains at least one of an oxide glass and an oxide glass ceramic.

7. The all-solid-state battery according to claim 1, wherein the lithium ion conductor contains at least one of silicon oxide, boron oxide, and tungsten oxide, and lithium oxide.

8. The all-solid-state battery according to claim 1, wherein the negative electrode contains carbon, silicon, or tin.

9. An electronic device, comprising
a board containing a polymer resin; and
the all-solid-state battery according to claim 1 mounted on the board,
wherein
the rising temperature of the exothermic peak is less than an ignition point of the polymer resin.

10. An electronic device, comprising
a chassis containing a polymer resin; and
the all-solid-state battery according to claim 1 mounted on the chassis,
wherein
the rising temperature of the exothermic peak is less than an ignition point of the polymer resin.

11. An electronic device that receives a supply of power from the all-solid-state battery according to claim 1.

12. An electronic card that receives a supply of power from the all-solid-state battery according to claim 1.

13. A wearable device that receives a supply of power from the all-solid-state battery according to claim 1.

14. An electric vehicle, comprising:
the all-solid-state battery according to claim 1;
a conversion device that receives a supply of power from the all-solid-state battery and converts the power to a driving force for the vehicle; and
a control device that performs information processing related to vehicle control based on information related to the all-solid-state battery.

15. A lithium ion conductor having an exothermic peak in a differential thermal analysis, wherein a first ionic conductivity on a first side of a temperature higher than a rising temperature of the exothermic peak is lower than a second ionic conductivity on a second side of a temperature lower than a rising temperature of the exothermic peak.

16. The lithium ion conductor according to claim 15, wherein the rising temperature of the exothermic peak is in a range of 300° C. to 550° C.

17. The lithium ion conductor according to claim 15, wherein a reduction rate of ionic conductivity expressed by [(σ(low T)−(high T))/σ(low T)]×100 is 85% or more,
where σ(low T)[S/cm] is the second ionic conductivity at Ta [° C.]−25 [° C.], σ(high T)[S/cm] is the first ionic conductivity at Ta [° C.]+25 [° C.], and Ta is the rising temperature [° C.] of the exothermic peak.

18. The lithium ion conductor according to claim 17, wherein the reduction rate of the ionic conductivity is 90% or more.

19. The lithium ion conductor according to claim 1, wherein the exothermic peak is an exothermic peak due to recrystallization of the lithium ion conductor.

20. The lithium ion conductor according to claim 1, wherein the lithium ion conductor contains at least one of an oxide glass and an oxide glass ceramic.
